(19) United States
(12) Patent Application Publication
(10) Pub. No.: US 2025/0314411 A1
(43) Pub. Date: Oct. 9, 2025

(54) ICE TANK ASSEMBLY

(71) Applicant: COWAY Co., Ltd., Gongju-si (KR)

(72) Inventors: Kwang Seok HONG, Gongju-si (KR); Jung Chul PARK, Gongju-si (KR); Do Han KIM, Gongju-si (KR)

(73) Assignee: COWAY Co., Ltd., Gongju-si (KR)

(21) Appl. No.: 19/098,070

(22) Filed: Apr. 2, 2025

(30) Foreign Application Priority Data
Apr. 8, 2024 (KR) 10-2024-0047460

(51) Int. Cl. F25C 5/182

(52) U.S. Cl. CPC F25C 5/182

(57) ABSTRACT

An ice tank assembly is disclosed. The ice tank assembly according to one aspect of the present invention may include an upper housing configured to have an upper housing space formed therein, a lower housing configured to be coupled with the upper housing and to have a lower housing space formed therein wherein the lower housing space communicates with the upper housing space; and an inner housing configured to be received in the lower housing space and to buffer an impact caused by ice falling from the upper housing space, wherein the lower housing may include a lower housing body surrounding the lower housing space, and wherein the inner housing may include an inner housing body configured to surround entire inner surfaces of the lower housing body.

### CROSS-REFERENCE TO RELATED APPLICATION

This application claims priority to and the benefit of Korean Patent Application No. 10-2024-0047460, filed on Apr. 8, 2024, the disclosures of which is incorporated herein by reference in its entirety.

### FIELD

The present invention relates to an ice tank assembly, and more specifically, to an ice tank assembly having a structure capable of reducing noise generated during falling while preventing contamination of a component provided therefor.

### BACKGROUND

The water purifier refers to a device that may receive raw water from the outside, filter it and provide the filtered raw water to a user. As the standard of living improves, the water purifier is widely used not only in commercial or business facilities but also in general homes.

The basic function of the water purifier is to filter the raw water and provide purified water to the outside. Recently, the water purifier capable of providing not only purified water but also hot or cold water by heating or cooling the purified water have been developed and utilized. Furthermore, the water purifier having a form capable of producing ice using the purified water and providing the generated ice is also gaining attention.

In the case of the water purifier capable of producing the ice, it is common to have a means for storing the produced ice. Since the ice is a solid phase, it is not desirable in terms of energy efficiency to produce the ice downwards and then move the produced ice upward against gravity. Accordingly, the water purifier having a form capable of dropping the produced ice downward and provide it to the outside according to the user's request are widely used.

However, when the ice is dropped, the ice may inevitably collide with the inside of the means, and there is a fear that the produced may be damaged. Further, when noise generated by the collision is radiated to the outside of the water purifier, there is a risk that the user's satisfaction may be reduced.

Recently, in order to reduce the impact and noise caused by the drop of the ice, a configuration having a layer of soft material inside the means for storing the ice has been added and used. The configuration is positioned on the inner surface of the means for storing the ice to reduce the impact and noise generated by the dropped ice.

However, a gap may be created between the inner surface of the means for storing the ice and the configuration. When the temperature of the means for storing the ice is arbitrarily changed to melt the ice or the purified water for producing the ice falls out, there is rick that the water may be introduced into the gap.

The water introduced into the gap may cause a biofilm such as a water stain. In this case, the produced ice also is contaminated, which may lead to accidents such as food poisoning.

Therefore, there is a need for a method for reducing the impact or noise generated when the ice is dropped and preventing the contamination of the ice.

Korean Patent Registration Document No. 10-2262828 discloses an inner tank and an ice water purifier including the same. Specifically, the inner tank and the ice water purifier including the same are disclosed that can reduce the generation of noise caused by the collision when the ice is supplied to an ice storage.

However, the inner tank disclosed by the prior art document is detachably coupled with the ice storage. That is, a gap is inevitably created between the inner tank of the prior art document and the inner surface of the ice storage. Therefore, the prior art document may reduce the impact or noise of dropped ice, but does not provide a method for preventing the contamination of the inner tank or the ice storage itself.

Korean Patent Registration Document No. 10-1331841 discloses an ice dropping noise reducing structure. Specifically, the ice dropping noise reducing structure is disclosed that includes an ice grill disposed on a lower side of an ice maker to reduce ice dropping noise caused by ice dropped from the ice maker.

However, the ice grill disclosed in the prior art document is positioned on the lower side of the ice maker and does not surround the inner surface of the means for storing ice. Therefore, the prior art document does not provide a method for reducing noise caused by ice dropped from the ice grill due to an increase in the amount of ice produced.

Furthermore, the prior art document does not provide a method for preventing contamination of the ice grill when ice seated on the ice grill melts and water is generated.
Korean Patent Registration Document No, 10-2262828 (2021 Jun. 9)
Korean Patent Registration Document No. 10-1331841 (2013 Nov. 21)

### SUMMARY

The present invention is to solve the above problems, and an object of the present invention is to provide an ice tank assembly having a structure capable of reducing noise or impact that may be generated when ice is dropped.

Another object of the present invention is to provide an ice tank assembly having a structure capable of reducing noise or impact even when ice is dropped in various directions.

Yet another object of the present invention is to provide an ice tank assembly having a structure capable of preventing a creation of a gap between a configuration for reducing noise or impact and a configuration for receiving ice.

Still another object of the present invention is to provide an ice tank assembly having a structure capable of preventing contamination between a configuration for reducing noise or impact and a configuration for receiving ice.

An additional object of the present invention is to provide an ice tank assembly having a structure capable of smoothly draining a fluid in a liquid phase remaining in a configuration for receiving ice.

An additional object of the present invention is to provide an ice tank assembly having a structure capable of smoothly operating a means for transferring ice to be provided to the outside.

The present invention has been made in view of the above problems, and other objects not mentioned will be apparent to those skilled in the art from the following description.

According to an aspect of the present invention, there is provided an ice tank assembly including: an upper housing configured to have an upper housing space formed therein, a lower housing configured to be coupled with the upper housing and to have a lower housing space formed therein, wherein the lower housing space communicates with the upper housing space; and an inner housing configured to be received in the lower housing space and to buffer an impact caused by ice falling from the upper housing space, wherein the lower housing includes a lower housing body surrounding the lower housing space, and wherein the inner housing includes an inner housing body configured to surround entire inner surfaces of the lower housing body.

In this case, the lower housing body may include first and second lower housing walls configured to surround the lower housing space on each side in a first direction; a third lower housing wall configured to surround the lower housing space on one side in a second direction; and a fourth lower housing wall configured to surround the lower housing space on one side in a height direction, and the inner housing body may include first to fourth inner housing walls configured to surround the first to fourth lower housing walls on an inner side and to be continuous with each other.

In addition, the lower housing may include coupling protrusions configured to protrude outward in a first direction and a second direction on an end of the lower housing body in a height direction, and the inner housing may include a housing coupler configured to be positioned on one side of the inner housing body in the height direction and to be coupled with each of the coupling protrusions.

In this case, the housing coupler may include a housing receiving space configured to be formed therein and to receive the end of the lower housing body in the height direction and the coupling protrusion; and a housing coupling groove configured to penetrate a surface surrounding the housing receiving space on an outer side in the first direction and the second direction, and the coupling projection may be inserted into the housing coupling groove.

In addition, the upper housing may include an upper housing body configured to surround the upper housing space; and an upper housing coupler configured to be positioned on one side of the upper housing body in the height direction and to be coupled with the coupling protrusion and the housing coupler.

In this case, the upper housing coupler may include an upper housing receptacle configured to be formed therein and to receive the coupling protrusion and the housing coupler; and a coupling opening configured to penetrate a surface surrounding the upper housing receptacle on an outer side in the first direction and the second direction, and the coupling projection may be inserted into the coupling opening.

In addition, the inner housing may include an inner housing rib configured to protrude on an outer surface of the inner housing body and to form a space between the outer surface of the inner housing body and the inner surface of the lower housing body.

In this case, the inner housing rib may include a first rib configured to extend along a first direction of an outer circumference of the inner housing body; and a second rib configured to intersect the first rib at a predetermined angle and to extend along a second direction of the outer circumference of the inner housing body.

In addition, the upper housing may include a pressing edge configured to be positioned on an end of a third direction and to protrude toward the inner housing to cover the end of the inner housing body in the third direction, and the inner housing may include an inner groove configured to be positioned adjacent to the end of the inner housing body in the third direction and to be recessed on one surface covered by the pressing edge to receive the pressing edge.

In this case, the inner groove may include a first groove configured to extend in a fourth direction corresponding to an extension direction of the pressing edge to receive the pressing edge; and a second groove configured to communicate with the first groove and to extend along the third direction, and the second groove may be configured such that its width decreases along a direction opposite to the first groove.

In addition, the upper housing may include a plurality of upper housing walls configured to surround the upper housing space on each side in a fifth direction and a sixth direction; and a pressing end configured to constitute an end of the plurality of upper housing walls in a height direction and to cover the inner housing body on an inner side, and the one end of the inner housing body in the height direction may be covered by the pressing end and is disposed to face the inner housing space surrounded by the inner housing body with the pressing end interposed therebetween.

In this case, the lower housing may include an inner housing receiving space configured to be recessed on an end of the lower housing body in a seventh direction, the inner housing may include a lower housing coupler configured to protrude from an end of the inner housing body in the seventh direction toward the lower housing and to be received the inner housing receiving space.

In addition, the lower housing may include a screw coupling hole configured to penetrate an end of the lower housing body in a ninth direction, wherein a screw is coupled through the screw coupling hole, and the inner housing may include a screw coupler configured to be positioned on an end of the inner housing body in the ninth direction, wherein the screw coupler is coupled through the screw coupling hole, and the screw is coupled through the screw coupler.

In this case, the screw coupler may include a lower housing coupling protrusion configured to protrude radially from an end of its extension direction and to be supported by an outer surface of the lower housing body; and a screw through hole configured to penetrate the inside thereof, wherein the screw penetrates the screw through hole.

According to the above configuration, the ice tank assembly according to the embodiment of the present invention may reduce noise or impact that may be generated when ice is dropped.

The ice tank assembly according to the embodiment of the present invention may reduce noise or impact even when ice is dropped in various directions.

The ice tank assembly according to the embodiment of the present invention may prevent a creation of a gap between a configuration for reducing noise or impact and a configuration for receiving ice.

The ice tank assembly according to the embodiment of the present invention may prevent contamination between a configuration for reducing noise or impact and a configuration for receiving ice.

The ice tank assembly according to the embodiment of the present invention may smoothly drain a fluid in a liquid phase remaining in a configuration for receiving ice.

The ice tank assembly according to the embodiment of the present invention may smoothly operate a means for transferring ice to be provided to the outside.

The effects of the present invention are not limited to the above-described effects, and it should be understood that the effects of the present invention include all effects that may be inferred from the detailed description of the present invention or the components of the present invention described in the claims.

### BRIEF DESCRIPTION OF THE DRAWINGS

FIG. 1 is a perspective view illustrating an ice tank assembly according to an embodiment of the present invention.

FIG. 2 is an exploded perspective view illustrating the ice tank assembly of FIG. 1.

FIG. 3 is a perspective view illustrating an outer housing provided in the ice tank assembly of FIG. 1.

FIG. 4 is a plan view illustrating the outer housing of FIG. 3.

FIG. 5 is a perspective view illustrating an upper housing provided in the ice tank assembly of FIG. 1.

FIG. 6 is a front view illustrating the upper housing of FIG. 5.

FIG. 7 is an A-A cross-sectional view illustrating the upper housing of FIG. 5.

FIG. 8 is an B-B cross-sectional view illustrating the upper housing of FIG. 5.

FIG. 9 is a perspective view illustrating a lower housing provided in the ice tank assembly of FIG. 1.

FIG. 10 is an enlarged perspective view of a portion “A” of the lower housing of FIG. 9.

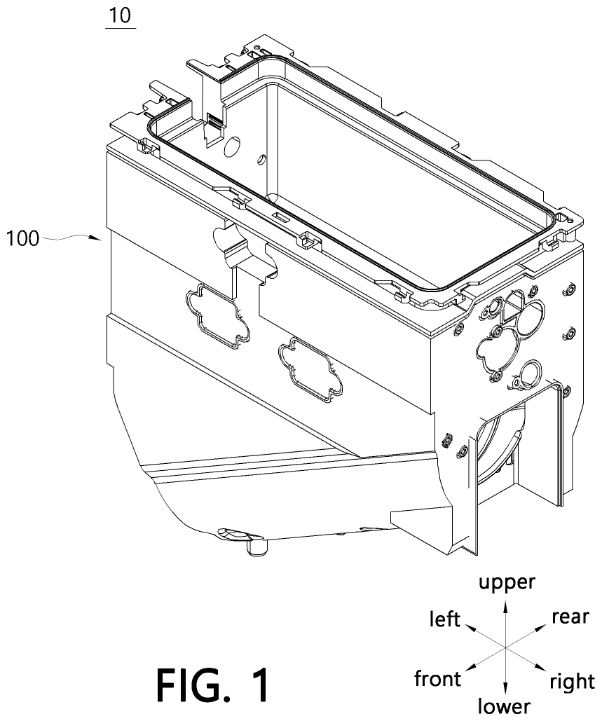

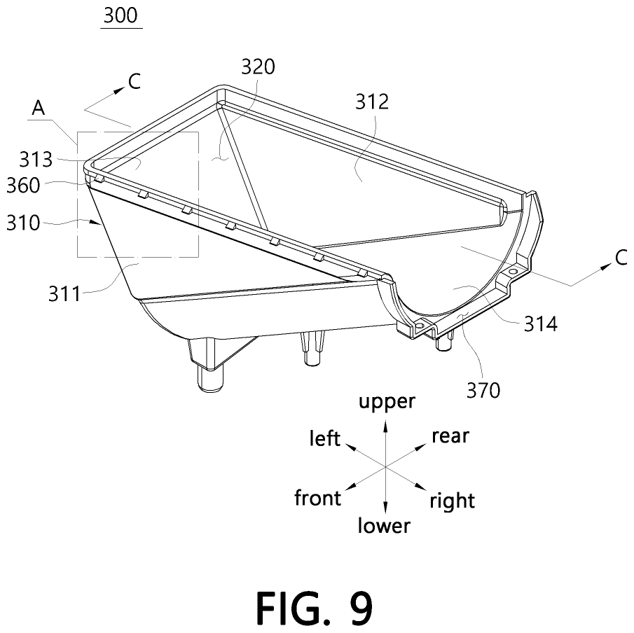

FIG. 1I is a front view illustrating the lower housing of FIG. 9.

FIG. 12 is a plan view illustrating the lower housing of FIG. 9.

FIG. 13 is an C-C cross-sectional view illustrating the lower housing of FIG. 9.

FIG. 14 is a perspective view illustrating an inner housing provided in the ice tank assembly of FIG. 1.

FIG. 15 is an enlarged perspective view of a portion “B” of the inner housing of FIG. 14.

FIG. 16 is a front view illustrating the inner housing of FIG. 14.

FIG. 17 is a right side view illustrating the inner housing of FIG. 14.

FIG. 18 is a left side view illustrating the inner housing of FIG. 14.

FIG. 19 is a plan view illustrating the inner housing of FIG. 14.

FIG. 20 is an enlarged plan view of a portion “C” of the inner housing of FIG. 19.

FIG. 21 is a bottom view illustrating the inner housing of FIG. 14.

FIG. 22 is an D-D cross-sectional view illustrating the inner housing of FIG. 14.

FIG. 23 is an E-E cross-sectional view illustrating the inner housing of FIG. 14.

FIG. 24 is an enlarged cross-sectional view of a portion “D” illustrating the inner housing of FIG. 23.

FIG. 25 is a perspective view illustrating an ice tank assembly according to an embodiment of the present invention,

FIG. 26 is an F-F cross-sectional view illustrating the ice tank assembly of FIG. 25.

FIG. 27 is an enlarged cross-sectional view of a portion “E” illustrating the ice tank assembly of FIG. 26,

FIG. 28 is an enlarged cross-sectional view of a portion “F” illustrating the ice tank assembly of FIG. 26.

FIG. 29 is an G-G cross-sectional view illustrating the ice tank assembly of FIG. 25.

FIG. 30 is an enlarged cross-sectional view of a portion “G” illustrating the ice tank assembly of FIG. 29.

FIG. 31 is an H-H cross-sectional view illustrating the ice tank assembly of FIG. 25.

FIG. 32 is an enlarged cross-sectional view of a portion “I” illustrating the ice tank assembly of FIG. 31.

### DETAILED DESCRIPTION

Hereinafter, embodiments of the present disclosure will be described in detail with reference to the accompanying drawings so that those skilled in the art can easily implement them. The present disclosure may be implemented in various different forms and is not limited to the embodiments described herein. In order to clearly explain the present disclosure, parts irrelevant to the description are omitted in the drawings, and the same or similar components are denoted by the same reference numerals throughout the entire specification.

The words and terms used in this specification and the claims are not interpreted as limited to ordinary or dictionary meanings, but should be interpreted as meanings and concepts consistent with the technical idea of the present disclosure according to the principle in which the inventor can define the terms and concepts in order to best explain their invention.

Therefore, the embodiments described in this specification and the configurations illustrated in the drawings correspond to a preferred embodiment of the present disclosure and do not all represent the technical idea of the present disclosure, so the corresponding configurations may be various equivalents and modifications to replace them at the time of filing the present disclosure.

In the following description, in order to clarify the features of the present disclosure, some components may be omitted.

The term “communication” used in the following description means that one or more members are connected to each other in fluid communication.

In an embodiment, the communication may be formed by a member such as a pipe, a pipe, or a pipe.

In the following description, communication may be used in the same sense that one or more members are “fluidly connected” to each other.

The term “electrical connection” used in the following description means that one or more members are connected to each other to transfer a current or electric signal. In an embodiment, the electrical connection may be formed in the form of a wire by a wire member or wireless such as Bluetooth, Wi-Fi, and RFID. In an embodiment, the electrical connection may include the meaning of “communication”.

The term “fluid” as used in the following description refers to any type of material that flows by external forces and may deform shape or volume, etc. In one embodiment, the fluid may be a liquid such as water or a gas such as air.

The terms “upper side”, “lower side”, “left side”, “right side”, “front side”, and “rear side” used in the following description will be understood with reference to coordinate systems illustrated throughout the accompanying drawings.

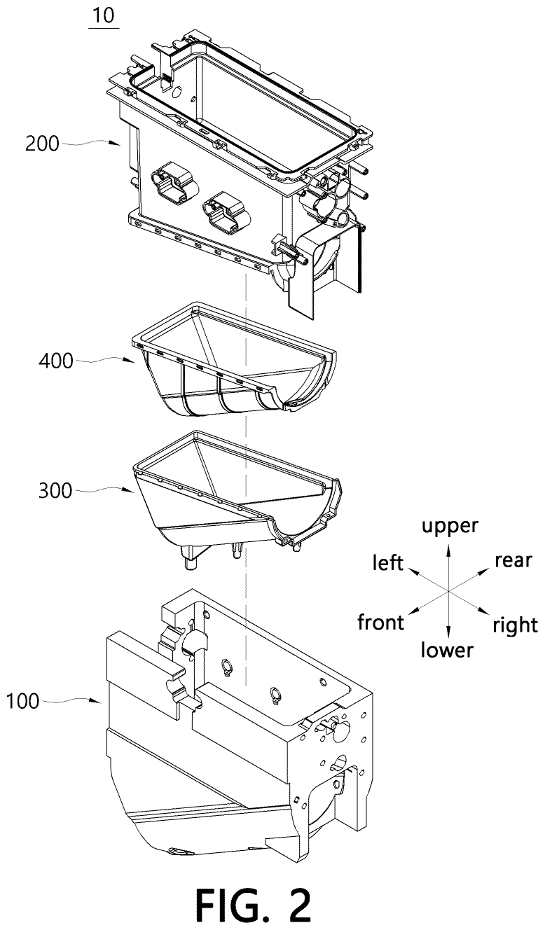

Referring to FIGS. 1 and 2, an ice tank assembly 10 according to an embodiment of the present invention is illustrated as an example. The ice tank assembly 10 may receive a fluid in a liquid phase from the outside and cool the received fluid to produce ice in a solid phase. The ice tank assembly 10 may store the produced ice and provide it to the outside. To this end, the ice tank assembly 10 may communicate with the outside.

The ice tank assembly 10 according to an embodiment of the present invention may be provided and utilized in any type of device capable of providing ice. In an embodiment, the ice tank assembly 10 may be provided and utilized in a water purifier, a refrigerator, or an ice maker. The following description assumes that the ice tank assembly 10 is provided and used in the water purifier.

In an embodiment in which the ice tank assembly 10 is provided and utilized in the water purifier, the ice tank assembly 10 may be fluidly connected to a configuration for filtering raw water using a filter to produce purified water. The ice tank assembly 10 may receive the purified water from the configuration.

In addition, the ice tank assembly 10 may be coupled with a configuration for cooling the water purified. The configuration may be at least partially positioned inside the ice tank assembly 10 to cool the purified water. In an embodiment, the configuration may include a refrigerant tube for allowing the refrigerant to flow.

Furthermore, the ice tank assembly 10 may be coupled with a configuration for providing the produced ice to the outside. The configuration may be positioned inside the ice tank assembly 10 to transfer the produced ice. In an embodiment, the configuration may be provided as a screw and rotatably coupled with the ice tank assembly 10.

Meanwhile, the ice tank assembly 10 according to the embodiment of the present invention may reduce impact or noise generated as the produced ice falls. To this end, the ice tank assembly 10 includes a configuration (i.e., the inner housing 400 to be described later) that surrounds a space where the ice is produced and received.

The configuration may be configured to at least partially surround an inner surface of the ice tank assembly 10. In an embodiment, the configuration may completely surround the lower side of the ice tank assembly 10, that is, a space from which the produced ice falls. Thus, even if the ice falls in any direction, the generated impact or noise may be reduced.

In an embodiment illustrated in FIGS. 1 and 2, the ice tank assembly 10 includes an outer housing 100, an upper housing 200, a lower housing 300, and an inner housing 400.

The outer housing 100 constitutes an outer shape of the ice tank assembly 10. A space is formed inside the outer housing 100. The upper housing 200, the lower housing 300, and the inner housing 400 are received in the space.

The outer housing 100 surrounds another configurations of the ice tank assembly 10, that is, the upper housing 200, the lower housing 300, and the inner housing 400 from the outside. The outer housing 100 supports the upper housing 200, the lower housing 300, and the inner housing 400.

The outer housing 100 is fluidly connected to the outside. A fluid in a liquid phase, such as a purified water, may be introduced into the outer housing 100. In addition, ice produced in the ice tank assembly 10 may be provided to the outside of the outer housing 100.

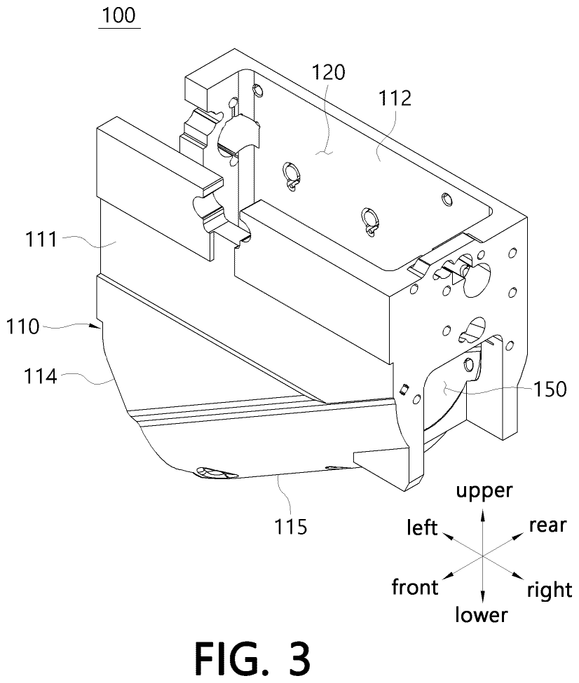

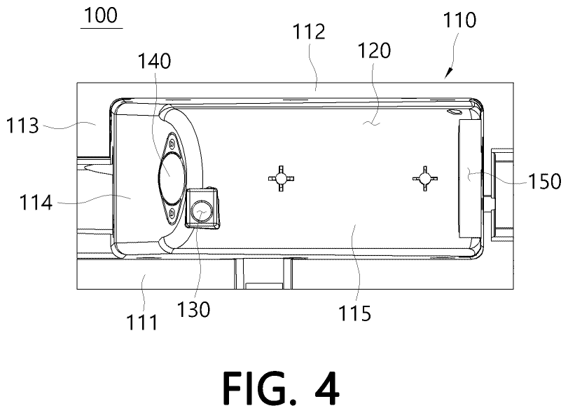

In an embodiment illustrated in FIGS. 3 and 4, the outer housing 100 includes an outer housing body 110, an outer housing space 120, an outer housing drain hole 130, a screw support 140, and a screw coupling opening 150.

The outer housing body 110 constitutes an outer shape of the outer housing 100. The outer housing body 110 surrounds the upper housing 200 and the lower housing 300 received in the outer housing space 120 from the outside.

The outer housing body 110 may have a shape corresponding to the shape of the upper housing 200 and the lower housing 300. In the illustrated embodiment, the outer housing body 110 has a three-dimensional shape having a length in the left-right direction longer than a width in the front-rear direction and a height in the up-down direction.

Another configuration of the outer housing 100 is formed or coupled with the outer housing body 110. In the illustrated embodiment, an outer housing space 120 is configured inside the outer housing body 110. An outer housing drain hole 130 is configured on one side of the outer housing body 110 in the height direction, preferably on a lower side in the illustrated embodiment.

The screw support 140 is coupled with one side of the outer housing body 110 in the longitudinal direction, preferably with a left side in the illustrated embodiment. The screw coupling opening 150 is configured on the other side of the outer housing body 110 in the longitudinal direction, preferably on a right side in the illustrated embodiment.

In the illustrated embodiment, the outer housing body 110 includes a first outer housing wall 111, a second outer housing wall 112, a third outer housing wall 113, a fourth outer housing wall 114, and a fifth outer housing wall 115.

The first outer housing wall 111 constitutes one side of the outer housing body 110. The first outer housing wall 111 surrounds the outer housing space 120 on the one side. In the illustrated embodiment, the first outer housing wall 111 constitutes a front side of the outer housing body 110.

The first outer housing wall 111 surrounds the outer housing space 120 on the front side. The first outer housing wall 111 is disposed to face a first upper housing wall 211 of the upper housing 200 received in the outer housing space 120.

The first outer housing wall 111 is disposed to face the second outer housing wall 112 with the outer housing space 120 interposed therebetween along the width direction of the outer housing 100, preferably a front-rear direction in the illustrated embodiment.

One side of the first outer housing wall 111 in the longitudinal direction, preferably a left side in the illustrated embodiment, is continuous with the third outer housing wall 113 and the fourth outer housing wall 114. One side of the first outer housing wall 111 in the height direction, preferably a lower side in the illustrated embodiment, is continuous with the fifth outer housing wall 115.

The second outer housing wall 112 constitutes another side of the outer housing body 110. A second outer housing wall 112 surrounds the outer housing space 120 on another side. In the illustrated embodiment, the second outer housing wall 112 constitutes a rear side of the outer housing body 110.

The second outer housing wall 1112 surrounds the outer housing space 120 on the rear side. The second outer housing wall 112 is disposed to face the second upper housing wall 212 of the upper housing 200 received in the outer housing space 120.

The second outer housing wall 112 is disposed to face the first outer housing wall 1111 with the outer housing space 120 interposed therebetween along the width direction of the outer housing 100, preferably a front-rear direction in the illustrated embodiment.

One side of the second outer housing wall 112 in the longitudinal direction, preferably a left side in the illustrated embodiment, is continuous with the third outer housing wall 113 and the fourth outer housing wall 114. One side of the second outer housing wall 112 in the height direction, preferably a lower side in the illustrated embodiment, is continuous with the fifth outer housing wall 115.

The third outer housing wall 113 constitutes yet another side of the outer housing body 110. The third outer housing wall 113 surrounds the outer housing space 120 on yet another side. In the illustrated embodiment, the third outer housing wall 113 constitutes a left side of the outer housing body 110.

The third outer housing wall 113 surrounds the outer housing space 120 on the left side. The third outer housing wall 113 is disposed to face a third upper housing wall 213 of the upper housing 200 received in the outer housing space 120.

Each side of the third outer housing wall 113 in the width direction, preferably a front side and a rear side in the illustrated embodiment, are continuous with the first outer housing wall 111 and the second outer housing wall 112, respectively. One side of the third outer housing wall 113 in the height direction, preferably a lower side in the illustrated embodiment, is continuous with the fourth outer housing wall 114.

The fourth outer housing wall 114 constitutes still another side of the outer housing body 110. The fourth outer housing wall 114 surrounds the outer housing space 120 on still another side. In the illustrated embodiment, the fourth outer housing wall 114 constitutes a lower left side of the outer housing body 110.

The fourth outer housing wall 114 surrounds the outer housing space 120 on the lower left side. The fourth outer housing wall 114 is disposed to face a third lower housing wall 313 of the lower housing 300 received in the outer housing space 120.

Each side of the fourth outer housing wall 114 in the width direction, preferably a front side and a rear side in the illustrated embodiment, are continuous with the first outer housing wall 111 and the second outer housing wall 112, respectively. Each side of the fourth outer housing wall 114 in the height direction, preferably an upper side and a lower side in the illustrated embodiment, are continuous with the third outer housing wall 113 and the fifth outer housing wall 115, respectively.

A screw support 140 is positioned on the fourth outer housing wall 114.

The fifth outer housing wall 115 constitutes an additional side of the outer housing body 110. A fifth outer housing wall 115 surrounds the outer housing space 120 on the additional side. In the illustrated embodiment, the fifth outer housing wall 115 constitutes a lower side of the outer housing body 110.

The fifth outer housing wall 115 surrounds the outer housing space 120 on the lower side. The fifth outer housing wall 115 is disposed to face a fourth lower housing wall 314 of the lower housing 300 received in the outer housing space 120.

The fifth outer housing wall 115 may have a shape corresponding to the shape of the fourth lower housing wall 314. In the illustrated embodiment, the fifth outer housing wall 115 extends in the left-right direction, and is rounded in a curved shape in which a height of one side in the longitudinal direction, that is, a left side, is lower than a height of the other side in the longitudinal direction, that is, a right side, and is convex toward a lower right side.

Each side of the fifth outer housing wall 115 in the width direction, preferably a front side and a rear side in the illustrated embodiment, are continuous with the first outer housing wall 111 and the second outer housing wall 112, respectively. Each side of the fifth outer housing wall 115 in the longitudinal direction, preferably a left side in the illustrated embodiment, is continuous with the fourth outer housing wall 114.

An outer housing drain hole 130 is formed in the fifth outer housing wall 115.

The outer housing space 120 is a space formed inside the outer housing 100. The outer housing space 120 is defined by being surrounded by the outer housing body 110. In the illustrated embodiment, the outer housing space 120 is surrounded by the outer housing body 110 on each side in the longitudinal direction and on each side in the width direction, that is, left, right, front, and rear sides.

In addition, one side of the outer housing space 120 in the height direction, preferably a lower side in the illustrated embodiment, is surrounded by the outer housing body 110, and the other side in the height direction, preferably an upper side in the illustrated embodiment, is configured open. A configuration for cooling the purified water to produce ice may be positioned on the other side of the outer housing space 120 in the height direction.

The outer housing space 120 communicates with the outside. The upper housing 200 received in the outer housing space 120 may get purified water from the outside. The ice produced in the outer housing space 120 may be provided to the outside.

The outer housing space 120 may have a shape corresponding to the shape of the outer housing body 110. In the illustrated embodiment, the outer housing space 120 is configured as a space in a three-dimensional shape having a polygonal cross-section in which a length in the left-right direction is longer than a width in the front-rear direction, and a height in the up-down direction. In this case, one side of the outer housing space 120 in the height direction, preferably a lower side in the illustrated embodiment, are configured to increase its height along the longitudinal direction.

The upper housing 200 is received on the other side of the outer housing space 120 in the height direction, preferably on an upper side in the illustrated embodiment. The lower housing 300 and the inner housing 400 coupled thereto are received at one side of the outer housing space 120 in the height direction, preferably at a lower side in the illustrated embodiment.

The outer housing space 120 communicates with the outside by the outer housing drain hole 130. Water generated inside the lower housing 300 or the inner housing 400 may be drained to the outside through the outer housing drain hole 130.

The outer housing space 120 communicates with the outside through the screw coupling opening 150. Ice stored in the lower housing 300 or the inner housing 400 may be moved by a screw (not illustrated) coupled with the ice tank assembly 10 and provided to the outside through the screw coupling opening 150.

The outer housing drain hole 130 constitutes a passage through which residual water generated inside the ice tank assembly 10 is drained. The outer housing drain hole 130 constitutes a portion in which the outer housing space 120 communicates with the outside.

The outer housing drain hole 130 is configured to penetrate one side of the outer housing body 110. In the illustrated embodiment, the outer housing drain hole 130 is configured through the fifth outer housing wall 115 constituting the lower side.

The outer housing drain hole 130 communicates with a lower drain hole 340 formed in the lower housing 300 and an inner drain hole 450 formed in the inner housing 400. The residual water generated inside the inner housing 400 may be drained to the outside through the outer housing drain hole 130 by passing through the inner drain hole 450 and the lower drain hole 340 in sequence.

The outer housing drain hole 130 may be any shape capable of communicating the outer housing space 120 with the outside. In the illustrated embodiment, the outer housing drain hole 130 is configured as an elliptical plate-shaped space having a circular cross-section and a thickness inclined in the up-down direction.

In the embodiment, the outer housing drain hole 130 may be disposed to overlap the lower drain hole 340 and the inner drain hole 450 along the thickness direction thereof.

The screw support 140 rotatably supports the screw (not illustrated) coupled with the outer housing 100. The screw support 140 is coupled with one side of the longitudinal direction of the screw (not illustrated), preferably with a left side in the illustrated embodiment.

The screw support 140 is coupled with the outer housing body 110. The screw support 140 may be supported by the outer housing body 110. In the illustrated embodiment, the screw support 140 is coupled with a lower side of the fourth outer housing wall 114. In other words, the screw support 140 is positioned on one side adjacent to the fifth outer housing wall 115 of the portion of the fourth outer housing wall 114.

The screw support 140 may include a configuration for coupling with the fourth outer housing wall 114 and a configuration for rotatably supporting the screw (not illustrated). In the illustrated embodiment, the central portion of the screw support 140 is rotatably coupled with the screw (not illustrated). Each side of the screw support 140 in the longitudinal direction, that is, a front side and a rear side, are coupled with the fourth outer housing wall 114.

The screw support 140 may be disposed to overlap a screw coupling hole 330 of the lower housing 300 and the screw coupler 460 of the inner housing 400.

The screw coupling opening 150 is a space through which the other side of the screw (not illustrated) in the longitudinal direction passes. The screw (not illustrated) may be coupled with a motor (not illustrated) or a support (not illustrated) positioned outside the outer housing 100 through the screw coupling opening 150.

The screw coupling opening 150 is configured to penetrate one side of the outer housing body 110 in the longitudinal direction. In the illustrated embodiment, the screw coupling opening 150 is positioned on the right side of the outer housing body 1110, opposite to the third outer housing wall 113 and the fourth outer housing wall 114. The screw coupling opening 150 is disposed to face the third and fourth outer housing walls 113 and 114 with the outer housing space 120 interposed therebetween.

The screw coupling opening 150 communicates the outside with the outer housing space 120. The screw coupling opening 150 is configured to penetrate the one side of the outer housing body 110, that is, a right wall.

The screw coupling opening 150 communicates with the discharge opening 230 of the upper housing 200. The ice stored in the lower housing 300 or the inner housing 400 may be provided to the outside through the screw coupling opening 150 and the discharge opening 230. The screw coupling opening 150 is disposed to overlap the discharge opening 230.

The screw coupling opening 150 may be configured in any shape that form a passage through which the screw (not illustrated) may pass and ice may be discharged by communicating the outside with the outer housing space 120. In the illustrated embodiment, the screw coupling opening 150 is configured as a cylindrical space having a circular cross-section and a height in the left-right direction.

The upper housing 200 is one configuration positioned inside the ice tank assembly 10. The upper housing 200 is respectively coupled with the outer housing 100, the lower housing 300, and the inner housing 400.

Specifically, the upper housing 200 is received in the outer housing space 120 and supported by the outer housing body 110. In addition, one side of the upper housing 200 in the height direction, preferably a lower side in the illustrated embodiment, is respectively coupled with the lower housing 300 and the inner housing 400 received in the outer housing space 120. The lower upper housing 200 is positioned on one side of the portion of the outer housing space 120 in the height direction, preferably on an upper side in the illustrated embodiment.

In this case, the one side of the upper housing 200 in the height direction may be positioned inside the lower housing 300 and the inner housing 400. In other words, the upper housing 200 may be disposed to press the lower housing 300 and the inner housing 400 toward the outside.

Therefore, a situation in which the residual water falling from the refrigerant pipe positioned on the upper side of the outer housing 100 leaks out to the outside of the upper housing 200 may be prevented.

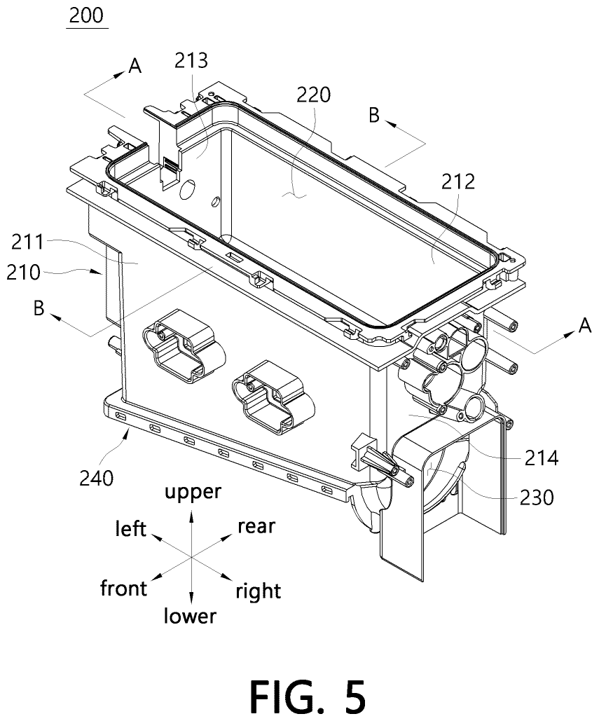

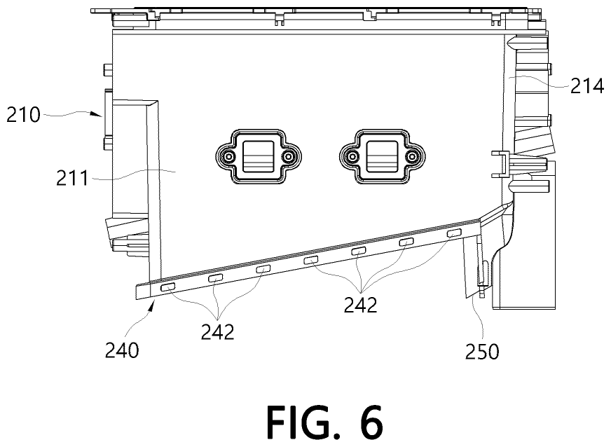

In the embodiment illustrated in FIGS. 5 to 8, the upper housing 200 includes an upper housing body 210, an upper housing space 220, a discharge opening 230, an upper housing coupler 240, and a pressing edge 250.

The upper housing body 210 constitutes an outer shape of the upper housing 200. The upper housing body 210 is received in the outer housing space 120 and surrounded by the outer housing body 110.

The upper housing body 210 may have a shape corresponding to the shape of the outer housing space 120. In the illustrated embodiment, the upper housing body 210 has a three-dimensional shape having a length in the left-right direction longer than a width in the front-rear direction and a height in an up-down direction.

Another configuration of the upper housing 200 is formed or coupled with the upper housing body 210. In the illustrated embodiment, an upper housing space 220 is configured inside the upper housing body 210. The discharge opening 230 is configured on one side of the upper housing body 210 in a longitudinal direction, preferably on a right side in the illustrated embodiment.

The upper housing coupler 240 and the pressing edge 250 are formed on one side of the upper housing body 210 in a height direction, preferably on a lower side in the illustrated embodiment.

In the illustrated embodiment, the upper housing body 210 includes a first upper housing wall 211, a second upper housing wall 212, a third upper housing wall 213, a fourth upper housing wall 214, and a pressing end 215.

The first upper housing wall 211 constitutes one side of the upper housing body 210. The first upper housing wall 211 surrounds the upper housing space 220 on the one side. In the illustrated embodiment, the first upper housing wall 211 constitutes a front side of the upper housing body 210. The first upper housing wall 211 is positioned between the first outer housing wall 111 and the upper housing space 220.

The first upper housing wall 211 is disposed to face the second upper housing wall 212 with the upper housing space 220 interposed therebetween along the width direction of the upper housing 200, preferably along a front-rear direction in the illustrated embodiment.

One side of the first upper housing wall 211 in the longitudinal direction, preferably a left side in the illustrated embodiment, is continuous with the third upper housing wall 213. The other side of the first upper housing wall 211 in the longitudinal direction, preferably a right side in the illustrated embodiment, is continuous with the fourth upper housing wall 214. One side of the first upper housing wall 211 in the height direction, preferably a lower side in the illustrated embodiment, is continuous with the upper housing coupler 240.

The second upper housing wall 212 constitutes the other side of the upper housing body 210. The second upper housing wall 212 surrounds the upper housing space 220 on the other side. In the illustrated embodiment, the second upper housing wall 212 constitutes a rear side of the upper housing body 210. The second upper housing wall 212 is positioned between the second outer housing wall 112 and the upper housing space 220.

The second upper housing wall 212 is disposed to face the first upper housing wall 211 with the upper housing space 220 interposed therebetween along the width direction of the upper housing 200, preferably a front-rear direction in the illustrated embodiment.

One side of the second upper housing wall 212 in the longitudinal direction, preferably a left side in the illustrated embodiment, is continuous with the third upper housing wall 213. The other side of the second upper housing wall 212 in the longitudinal direction, preferably a right side in the illustrated embodiment, is continuous with the fourth upper housing wall 214. One side of the second upper housing wall 212 in the height direction, preferably a lower side in the illustrated embodiment, is continuous with the upper housing coupler 240.

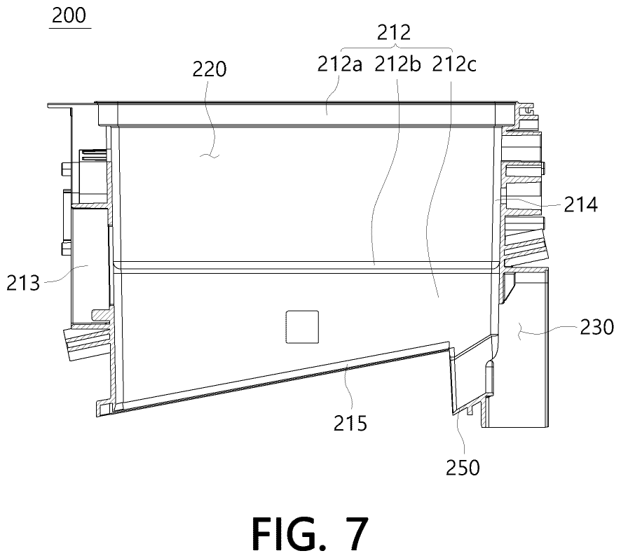

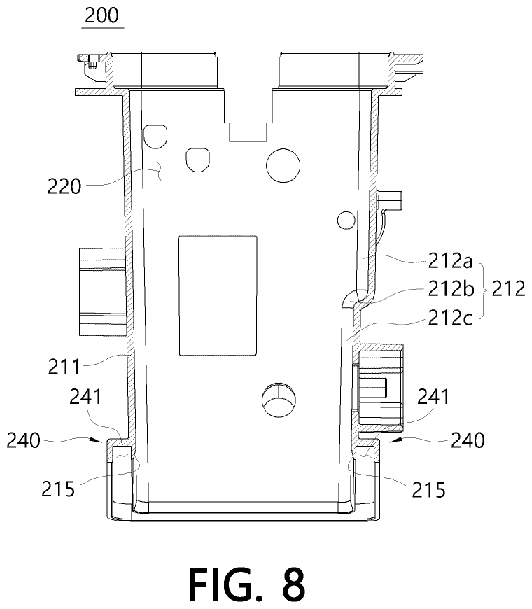

The second upper housing wall 212 may be divided into a plurality of portions along its height direction. As best illustrated in FIGS. 7 and 8, the second upper housing wall 212 includes a first upper extension 212a, a second upper extension 212b, and a third upper extension 212c.

The first upper extension 212a constitutes one side of the second upper housing wall 212 in the height direction, preferably an upper side in the illustrated embodiment. The first upper extension 212a is positioned on the outer side in the width direction, that is, a rear side compared to the third upper extension 212c. The first upper extension 212a extends in the height direction of the second upper housing wall 212, preferably in an up-down direction in the illustrated embodiment.

One side of the first upper extension 212a in the extension direction, preferably a lower end in the illustrated embodiment, is continuous with the second upper extension 212b.

The second upper extension 212b is continuous with the first upper extension 212a and the third upper extension 212c, respectively. The second upper extension 212b extends to one side of the upper housing body 210 in the width direction, preferably to a front side in the illustrated embodiment. One end of the second upper extension 212b in the extension direction, preferably a front end in the illustrated embodiment, is continuous with the third upper extension 212c.

The third upper extension 212c constitutes the other side of the second upper housing wall 212 in the height direction, preferably a lower side in the illustrated embodiment. The third upper extension 212c is positioned on the inner side in the width direction, that is, on a front side compared to the first upper extension 212a. The third upper extension 212c extends in the height direction of the second upper housing wall 212, preferably in an up-down direction in the illustrated embodiment.

One side of the third upper extension 212c in the height direction, preferably an upper end in the illustrated embodiment, is continuous with the second upper extension 212b. On the other side of the third upper extension 212c in the height direction, preferably a lower end in the illustrated embodiment, is continuous with the upper housing coupler 240. In this case, the first to third upper extensions 212a, 212b, and 212c may be configured to be rounded at each edge that are continuous with each other.

As the first to third upper extensions 212a, 212b, and 212c are formed, the residual water flowing along the second upper housing wall 212 may be guided toward the inside of the upper housing space 220. As described below, the upper housing 200 is positioned inside the lower housing 300 and the inner housing 400, and the residual water is guided to the inner housing 400, but is not leaked out of the inner housing 400.

The third upper housing wall 213 constitutes another side of the upper housing body 210. The third upper housing wall 213 surrounds the upper housing space 220 on another side. In the illustrated embodiment, the third upper housing wall 213 constitutes a left side of the upper housing body 210. The third upper housing wall 213 is positioned between the third outer housing wall 113 and the upper housing space 220.

The third upper housing wall 213 is disposed to face the fourth upper housing wall 214 with the upper housing space 220 interposed therebetween along the longitudinal direction of the upper housing 200, preferably a left-right direction in the illustrated embodiment.

Each side of the third upper housing wall 213 in the width direction, preferably a front side and a rear side in the illustrated embodiment, are continuous with the first upper housing wall 211 and the second upper housing wall 212, respectively. One side of the third upper housing wall 213 in the height direction, preferably a lower side of the third upper housing wall 213 in the illustrated embodiment, is continuous with the upper housing coupler 240.

The fourth upper housing wall 214 constitutes yet another side of the upper housing body 210. The fourth upper housing wall 214 surrounds the upper housing space 220 on yet another side. In the illustrated embodiment, the fourth upper housing wall 214 constitutes a right side of the upper housing body 210. The fourth upper housing wall 214 is positioned between the fourth outer housing wall 114 and the upper housing space 220.

The fourth upper housing wall 214 is disposed to face the third upper housing wall 213 with the upper housing space 220 interposed therebetween along the longitudinal direction of the upper housing 200, preferably a left-right direction in the illustrated embodiment.

Each side of the fourth upper housing wall 214 in the width direction, preferably a front side and a rear side of the fourth upper housing wall 214 in the illustrated embodiment, are continuous with the first upper housing wall 211 and the second upper housing wall 212. One side of the fourth upper housing wall 214 in the height direction, preferably a lower side of the fourth upper housing wall 214 in the illustrated embodiment, is continuous with the upper housing coupler 240.

The fourth upper housing wall 214 has the discharge opening 230.

The pressing end 215 is a portion in which the upper housing body 210 presses the lower housing 300 and the inner housing 400 coupled thereto.

The pressing end 215 supports the housing coupler 470 of the inner housing 400 in the width direction. In other words, the pressing end 215 covers the housing coupler 470 on the inner side.

Therefore, the residual water falling from the upper side to the lower side may be collected in the inner housing space 420 without escaping to the outside of the inner housing 400.

The pressing end 215 may be defined as a lower end of the first to fourth upper housing walls 211, 212, 213 and 214. That is, as best illustrated in FIG. 8, the pressing end 215 is positioned in the width direction of the upper housing coupler 240 along the longitudinal direction and the width direction of the portions of the first to fourth upper housing walls 211, 212, 213 and 214 and is configured to cover the housing coupler 470 on the inner side.

The upper housing space 220 is a space formed inside the upper housing 200. The upper housing space 220 is defined by being surrounded by the upper housing body 210. In the illustrated embodiment, the upper housing space 220 is surrounded by the upper housing body 210 on each side in the longitudinal direction and on each side in the width direction, that is, left, right, front, and rear sides.

In addition, one side of the upper housing space 220 in the height direction, preferably an upper side in the illustrated embodiment, may be configured open to form a space where ice is produced and dropped. The other side of the lower housing space 220 in the height direction, preferably a lower side in the illustrated embodiment, is configured open and communicates the lower housing space 320 with the inner housing space 420.

The upper housing space 220 communicates with the outside or the outer housing space 120. The purified water to be produced as ice may be introduced into the upper housing space 220.

The upper housing space 220 may have a shape corresponding to the shape of the upper housing body 210. In the illustrated embodiment, the upper housing space 220 is configured as a space in a three-dimensional shape having a polygonal cross-section in which a length in the left-right direction is longer than a width in the front-rear direction, and a height in the up-down direction. In this case, the other side, that is, a lower side of the upper housing space 220 in the height direction is configured to increase its height along the longitudinal direction.

The upper housing space 220 communicates with the outside through the discharge opening 230. The produced ice may be provided to the outside through the discharge opening 230.

The discharge opening 230 is a passage through which the produced ice is provided to the outside. In addition, the discharge opening 230 is a space through which the other side of the screw (not illustrated) in the longitudinal direction passes. The screw (not illustrated) may be connected to a motor (not illustrated) or a support (not illustrated) positioned outside the outer housing 100 by sequentially penetrating the screw coupling opening 150 and the discharge opening 230.

The discharge opening 230 is configured to penetrate one side of the upper housing body 210 in the longitudinal direction, preferably the fourth upper housing wall 214 positioned on the right side in the illustrated embodiment. The discharge opening 230 communicates the upper housing space 220 with the outside.

The discharge opening 230 communicates with the screw coupling opening 150. The discharge opening 230 may be disposed to overlap the screw coupling opening 150 along the longitudinal direction of the upper housing 200, preferably along a left-right direction in the illustrated embodiment.

The discharge opening 230 may be configured in any shape that form a passage through which the screw (not illustrated) may pass and ice may be discharged by communicating the upper housing space 220 with the outside. In the illustrated embodiment, the discharge opening 230 is configured as a cylindrical space having a circular cross-section and a height in the left-right direction.

The upper housing coupler 240 is a portion where the upper housing 200 is coupled with the lower housing 300 and the inner housing 400. The upper housing coupler 240 is positioned adjacent to one side of the upper housing body 210 in the height direction, preferably a lower end in the illustrated embodiment. The lower housing coupler 240 is positioned outside the pressing end 215.

The upper housing coupler 240 may be formed on each of a plurality of upper housing walls 211, 212, 213, and 214. In the illustrated embodiment, the upper housing coupler 240 extends along the outer circumference of the upper housing body 210 and is formed on each of lower ends of the first to fourth upper housing walls 211, 212, 213, and 214.

The lower housing coupler 240 is coupled with the lower housing 300. Specifically, the upper housing coupler 240 may receive an upper end of the lower housing body 310 and may be coupled with the coupling protrusion 360. The lower housing coupler 240 surrounds the lower housing body 310 on the outer side in the longitudinal direction and the width direction.

The upper housing coupler 240 is coupled with the inner housing 400. The upper housing coupler 240 may receive the housing coupler 470 and support the same. A detailed description of the coupling structure will be described later.

The upper housing coupler 240 may include a configuration coupled with the lower housing 300 or the inner housing 400 and a configuration receiving the lower housing 300 or the inner housing 400.

In the illustrated embodiment, the upper housing coupler 240 includes an upper housing receptacle 241 and a coupling opening 242.

The upper housing receptacle 241 is a space formed inside the upper housing coupler 240. The upper housing receptacle 241 is defined by being partially surrounded by an outer side of the upper housing coupler 240 and the pressing end 215.

That is, in the illustrated embodiment, the outer side of the upper housing receptacle 241 in the width direction and the longitudinal direction is surrounded by the upper housing coupler 240. An inner side of the upper housing receptacle 241 in the width direction and the longitudinal direction is surrounded by the pressing end 215.

The upper housing receptacle 241 receives the lower housing 300 and the inner housing 400. Specifically, the upper housing receptacle 241 receives an upper end of the lower housing body 310. In addition, the upper housing receptacle 241 receives an upper end of the inner housing body 410 and the housing coupler 470.

The upper housing receptacle 241 communicates with the coupling opening 242. The coupling protrusion 360 received in the upper housing receptacle 241 may be inserted into and coupled with the coupling opening 242.

The coupling opening 242 receives the coupling protrusion 360. In an embodiment, the coupling opening 242 may receive the coupling protrusion 360 in a retractable manner.

The coupling opening 242 is formed in a portion positioned outside the longitudinal direction and the width direction of the portion of the upper housing coupler 240. In other words, the coupling opening 242 is positioned outside compared to the upper housing receptacle 241. The coupling opening 242 is disposed to face the pressing edge 250 or the upper housing space 220 with the upper housing receptacle 241 interposed therebetween.

The coupling opening 242 may be configured to penetrate the portion of the upper housing coupler 240. In the illustrated embodiment, the coupling opening 242 is configured to penetrate the upper housing coupler 240 along the width direction or the longitudinal direction.

The coupling opening 242 may be any shape capable of communicating with the upper housing receptacle 241 and receiving the coupling protrusion 360. In the illustrated embodiment, the coupling opening 242 is configured in a space having an oblong-shaped shape such that a length in the horizontal direction is longer than a height in the up-down direction and each end in the longitudinal direction is rounded and convex outward.

A plurality of coupling openings 242 may be provided. The plurality of coupling openings 242 may be spaced apart from each other along the extension direction of the upper housing coupler 240. Each of a plurality of coupling protrusions 360 are inserted into and coupled with each of the plurality of coupling openings 242.

The upper housing 200, the lower housing 300, and the inner housing 400 may be simultaneously coupled by coupling the coupling protrusion 360 with the coupling opening 242. The detailed description thereof will be described later.

The pressing edge 250 is a portion where the upper housing 200 wraps around the inner housing 400. The pressing edge 250 wraps around one side of a fourth inner housing wall 414 of the inner housing 400 in the longitudinal direction, preferably a front side in the illustrated embodiment. In an embodiment, the pressing edge 250 may pressurize the one side of the fourth inner housing wall 414.

Therefore, the residual water formed in the upper housing space 220 may flow to the inner drain hole 450 along the fourth inner housing wall 414 without being introduced between the upper housing 200 and the inner housing 400.

The pressure edge 250 is continuous with the upper housing coupler 240. Specifically, the pressing edge 250 configured to extend downward from one side of the upper housing 200 in the longitudinal direction of the portion of the upper housing coupler 240, preferably a lower end of the front in the illustrated embodiment.

The pressure edge 250 may at least partially cover the one side of the fourth inner housing wall 414. In an embodiment, the pressing edge 250 may cover a portion including the one end of the fourth inner housing wall 414. The pressing edge 250 may be positioned adjacent to the inner groove 440 formed in the fourth inner housing wall 414.

The pressing edge 250 may have a length of the fourth inner housing wall 414 in the width direction, preferably in a left-right direction in the illustrated embodiment. The length of the pressing edge 250 may be greater than or equal to the length of the fourth inner housing wall 414 in the width direction.

Thus, the pressing edge 250 may have a width of the fourth inner housing wall 414 in the longitudinal direction, preferably in a front-rear direction in the illustrated embodiment. The width of the pressing edge 250 may be less than or equal to the distance between the front end of the fourth inner housing wall 414 and the inner groove 440.

Thus, the pressing edge 250 may cover the front side of the fourth inner housing wall 414 without covering the inner groove 440. Accordingly, the residual water generated in the upper housing space 220 may flow along the pressing edge 250 and be guided to the inner groove 440.

The lower housing 300 is another configuration positioned inside the ice tank assembly 10. The lower housing 300 is coupled with the outer housing 100, the upper housing 200, and the inner housing 400, respectively.

Specifically, the lower housing 300 is received in the outer housing space 120 and supported by the outer housing body 110. In addition, one side of the lower housing 300 in the height direction, preferably an upper side in the illustrated embodiment, are coupled with the upper housing 200. In addition, the lower housing 300 receives the inner housing 400 in a space formed therein. The lower housing 300 may be coupled with the upper housing 200 by the inner housing 400.

In this case, the one side of the lower housing 300 in the height direction may be positioned between the upper housing 200 and the inner housing 400. In other words, the lower housing 300 may be supported by the upper housing 200 and the inner housing 400, respectively.

Therefore, the residual water falling from the upper housing 200 may not flow out to the outside of the lower housing 300 or the lower housing 300, but may flow into the inner housing 400.

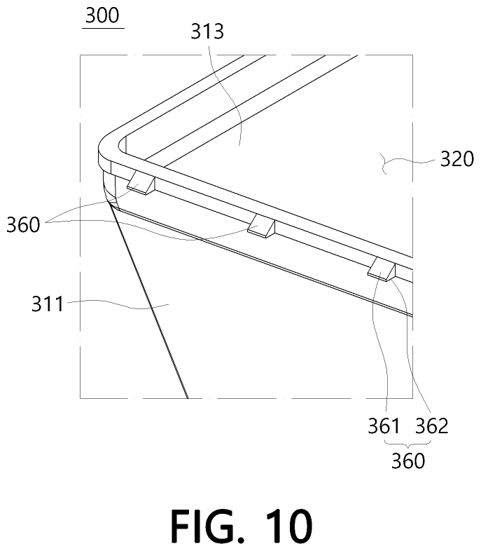

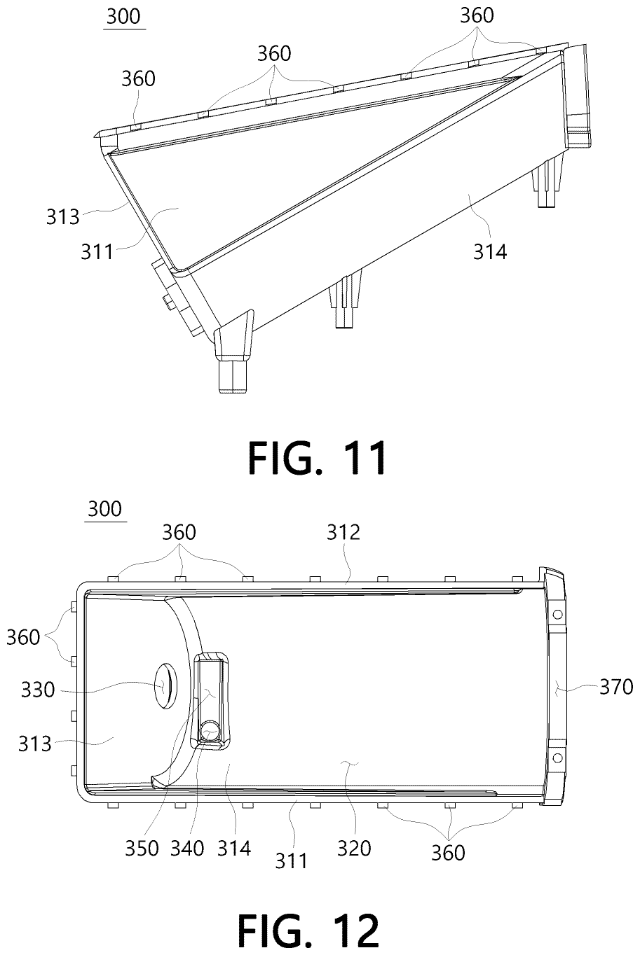

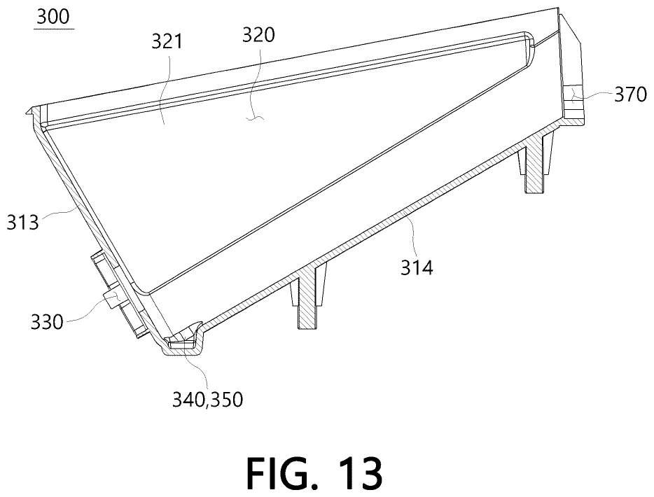

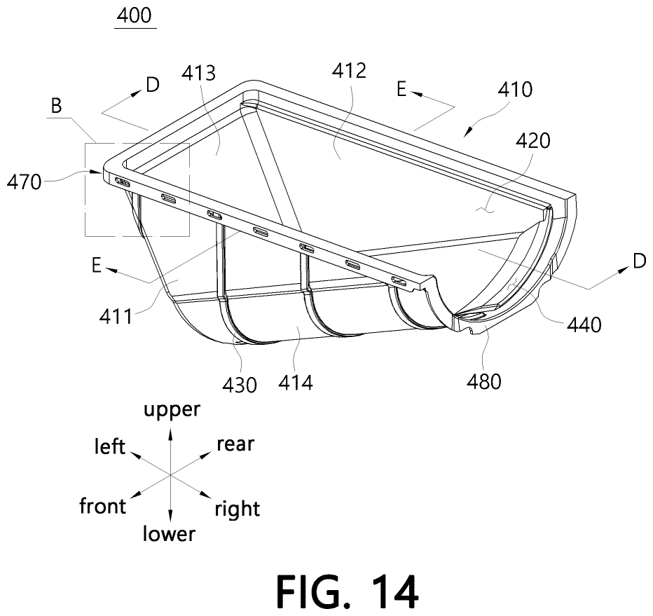

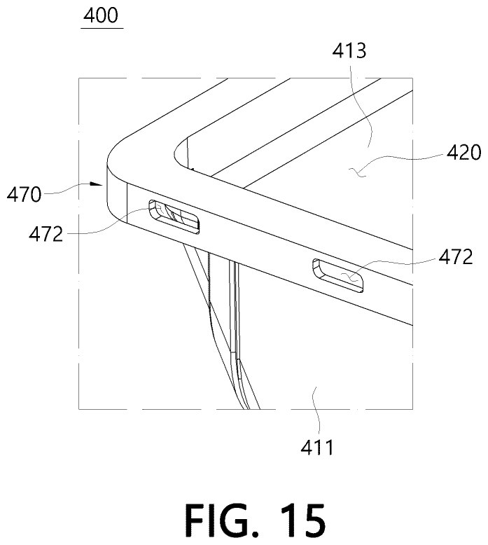

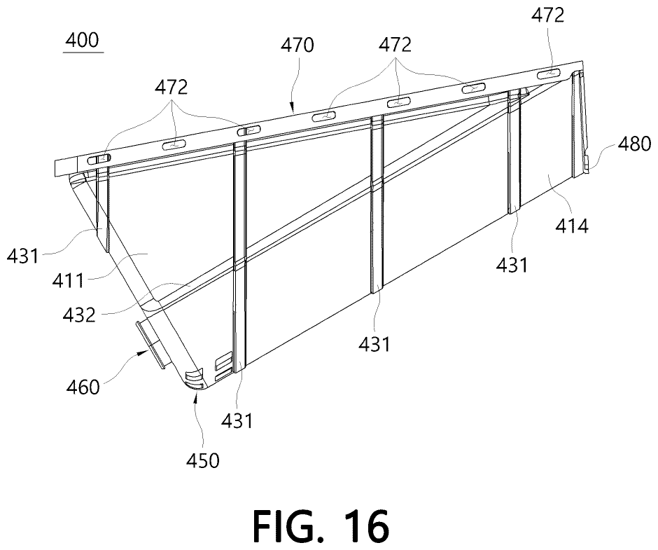

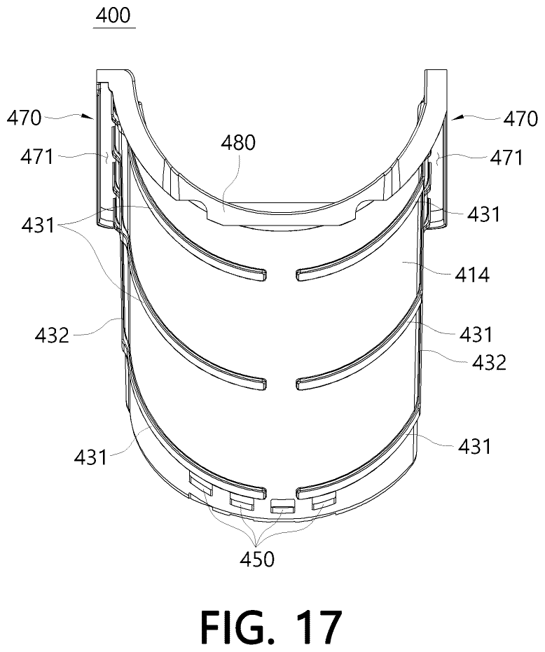

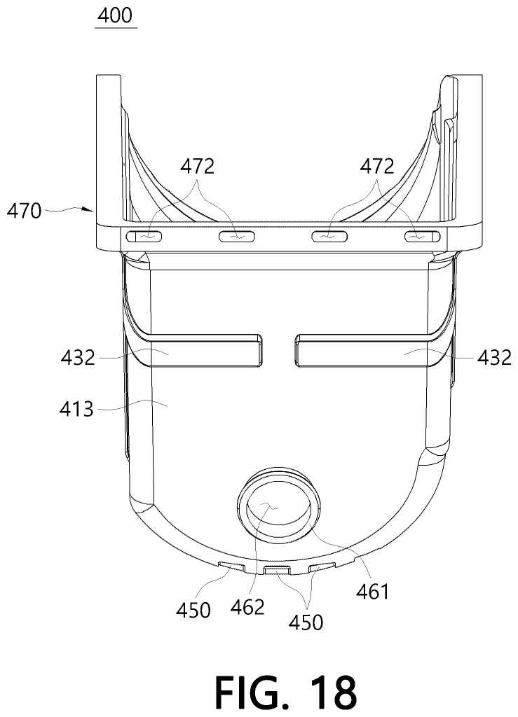

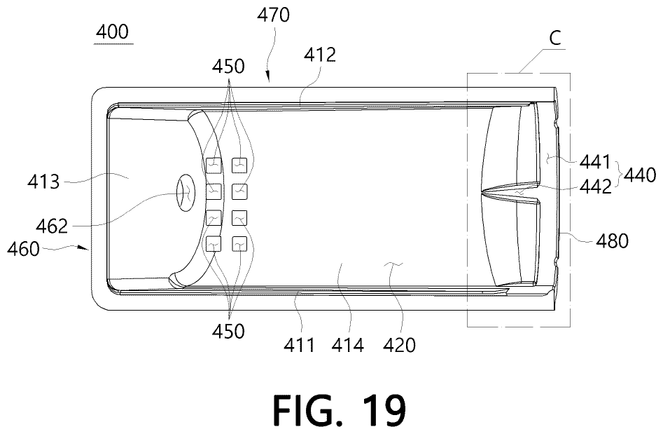

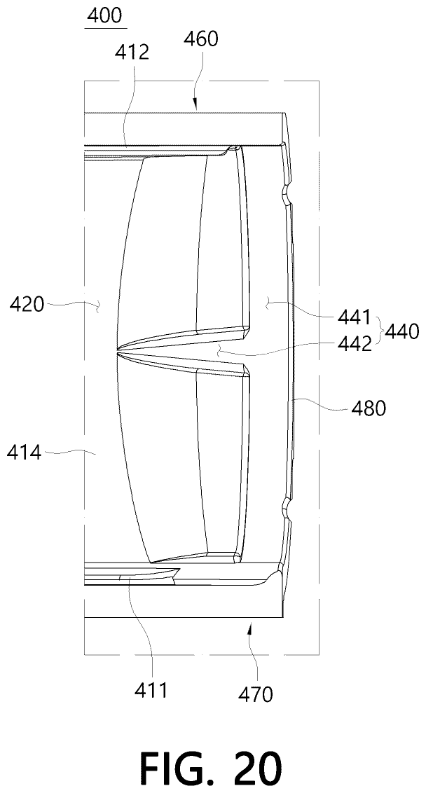

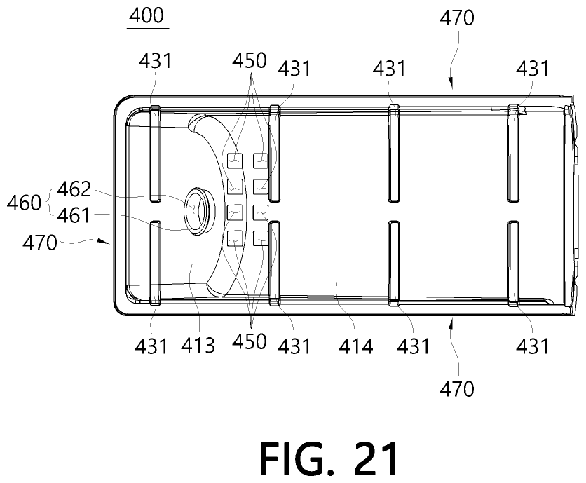

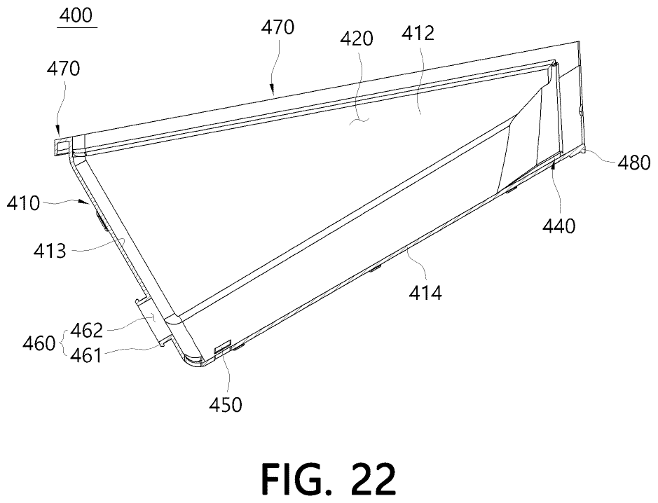

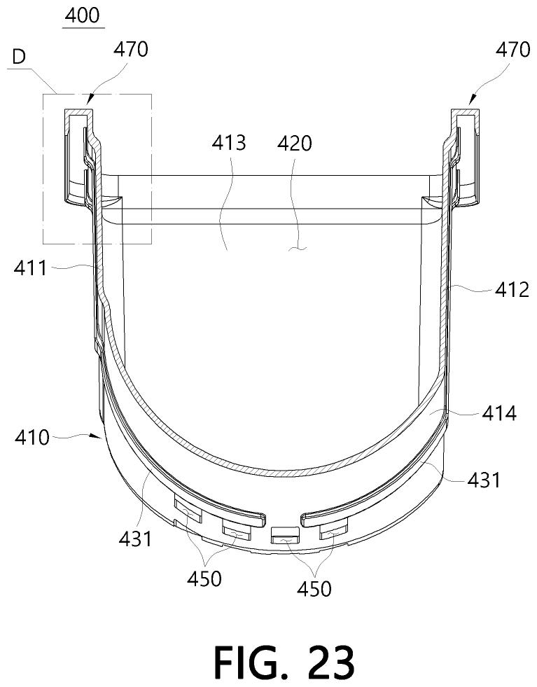

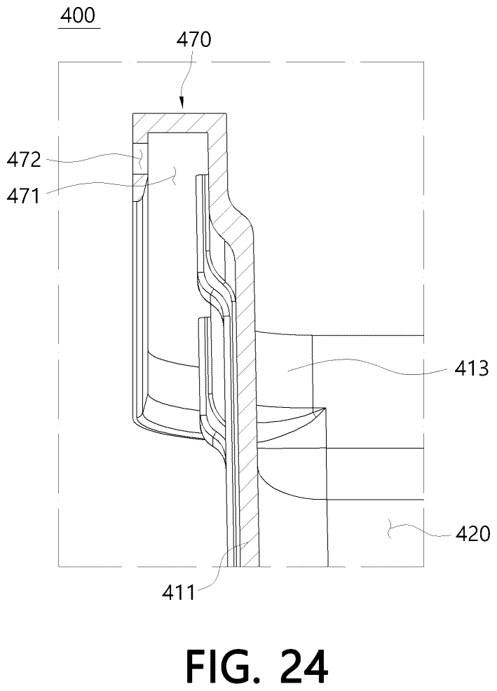

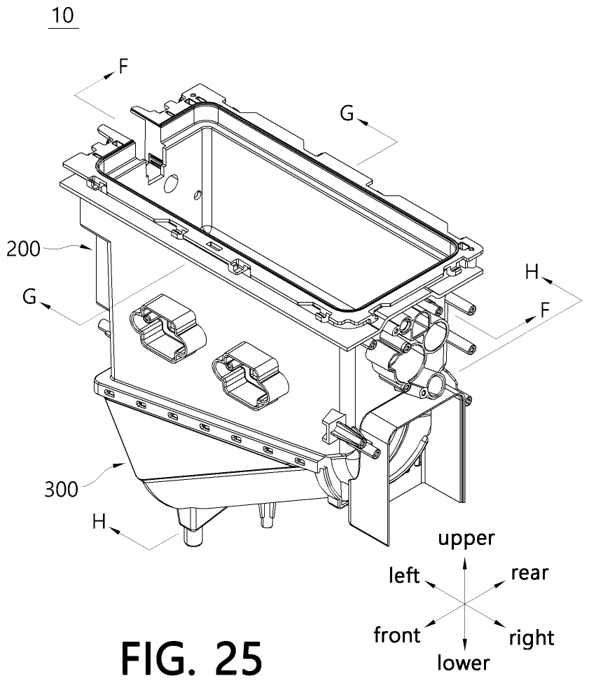

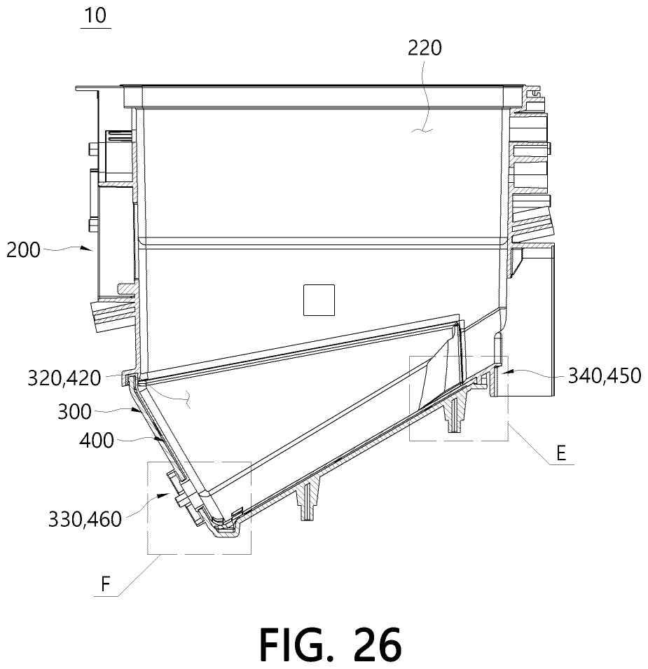

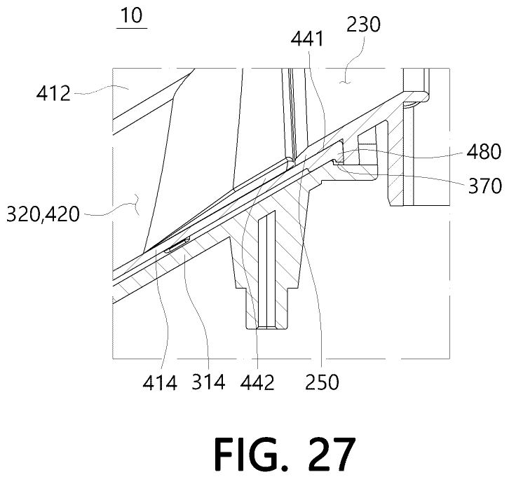

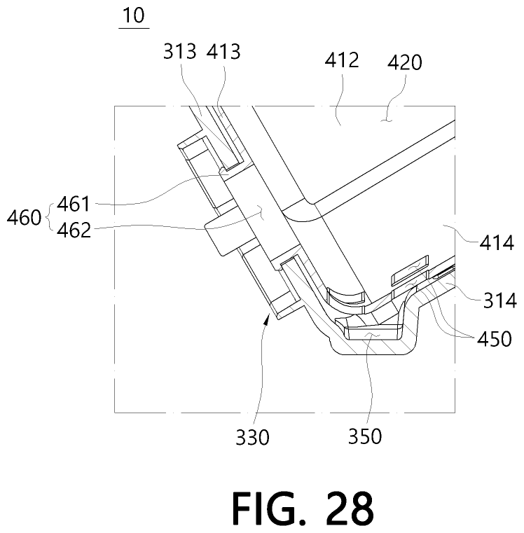

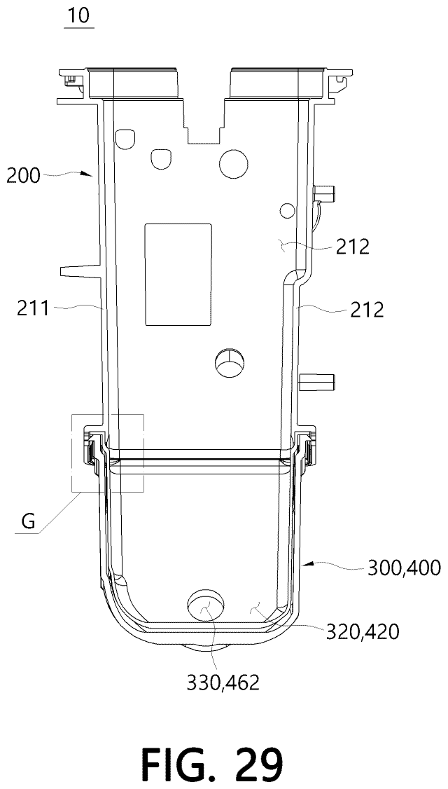

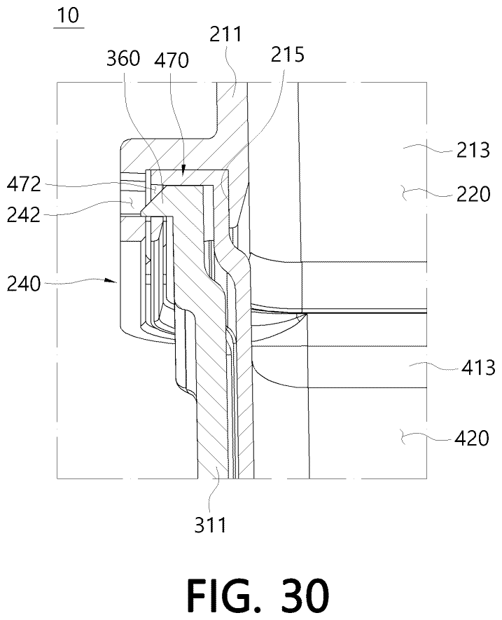

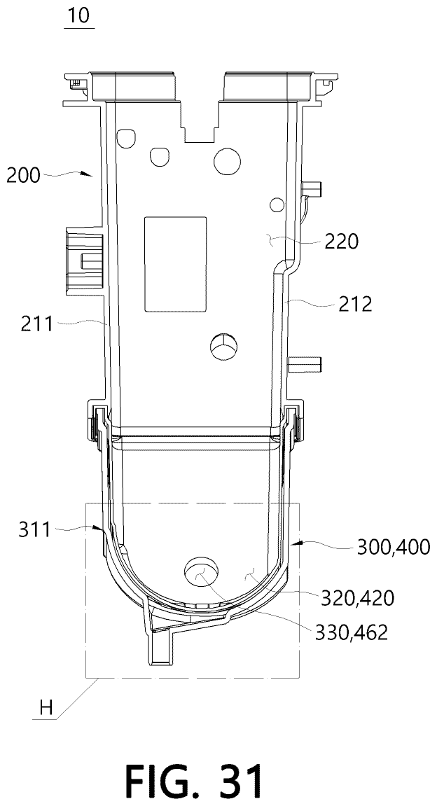

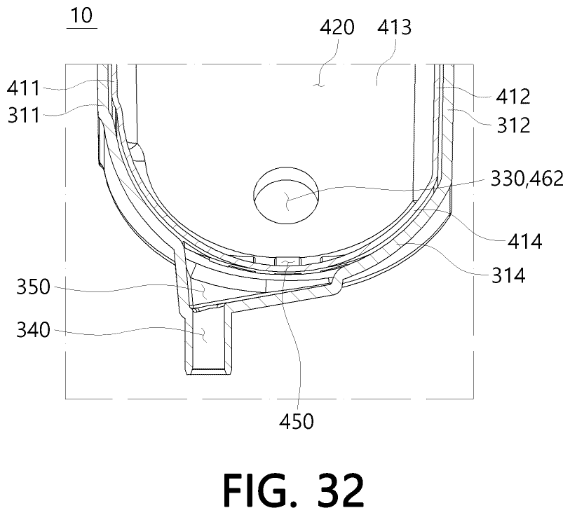

In the embodiment illustrated in FIGS. 9 to 13, the lower housing 300 includes a lower housing body 310, a lower housing space 320, a screw coupling hole 330, a lower drain hole 340, a lower drain recess 350, a coupling protrusion 360, and an inner housing receiving space 370.

The lower housing body 310 constitutes the outer shape of the lower housing 300. The lower housing body 310 is received in the outer housing space 120 and is surrounded by the outer housing body 110.

The lower housing body 310 may have a shape corresponding to the shape of the outer housing space 120. In the illustrated embodiment, the lower housing body 310 has a three-dimensional shape having a length in the left-right direction longer than a width in the front-rear direction and a height in the up-down direction, corresponding to a shape of a lower side of the outer housing space 120.

In this case, one side of the lower housing body 310 in a height direction, preferably a lower side in the illustrated embodiment, are configured so that a height thereof changes along the longitudinal direction. In other words, the lower side of the lower housing body 310 is configured to be inclined along the left-right direction. The lower side of the lower housing body 310 may be supported by the fifth outer housing wall 115.

Another configuration of the lower housing 300 is formed or coupled with the lower housing body 310. In the illustrated embodiment, a lower housing space 320 is configured inside the lower housing body 310. A screw coupling hole 330 is configured on one side of the lower housing body 310 in the longitudinal direction, preferably on a left side in the illustrated embodiment. An inner housing receiving space 370 is configured on the other side of the lower housing body 310 in the longitudinal direction, preferably on a right side in the illustrated embodiment.

A lower drain hole 340 and a lower drain recess 350 are formed on one side of the lower housing body 310 in the height direction, preferably on a lower side in the illustrated embodiment. A coupling protrusion 360 is positioned on the other side of the lower housing body 310 in the height direction, preferably on an upper side in the illustrated embodiment.

In the illustrated embodiment, the lower housing body 310 includes a first lower housing wall 311, a second lower housing wall 312, a third lower housing wall 313, and a fourth lower housing wall 314.

The first lower housing wall 311 constitutes one side of the lower housing body 310. The first lower housing wall 311 surrounds the lower housing space 320 on the one side. In the illustrated embodiment, the first lower housing wall 311 constitutes a front side of the lower housing body 310. The first lower housing wall 311 is positioned between the first outer housing wall 111 and the lower housing space 320.

The first lower housing wall 311 is disposed to face the second lower housing wall 312 with the lower housing space 320 interposed therebetween along the width direction, preferably a front-rear direction in the illustrated embodiment.

One side of the first lower housing wall 311 in the longitudinal direction, preferably a left side in the illustrated embodiment, is continuous with the third lower housing wall 313. One side of the first lower housing wall 311 in the height direction, preferably a lower side in the illustrated embodiment, is continuous with the fourth lower housing wall 314.

The other side of the first lower housing wall 311 in a longitudinal direction, preferably a right side in the illustrated embodiment, is partially surrounding the inner housing receiving space 370. The coupling protrusion 360 is formed on one side of the first lower housing wall 311 in the height direction, preferably on an upper side in the illustrated embodiment. The first lower housing wall 311 may be coupled with the upper housing 200 and the inner housing 400 through the coupling protrusion 360.

The second lower housing wall 3112 constitutes the other side of the lower housing body 310. The second lower housing wall 312 surrounds the lower housing space 320 on the other side. In the illustrated embodiment, the second lower housing wall 312 constitutes a rear side of the lower housing body 310. The second lower housing wall 312 is positioned between the second outer housing wall 112 and the lower housing space 320.

The second lower housing wall 312 is disposed to face the first lower housing wall 311 with the lower housing space 320 interposed therebetween along the width direction of the lower housing 300, preferably a front-rear direction in the illustrated embodiment.

One side of the second lower housing wall 312 in the longitudinal direction, preferably a left side in the illustrated embodiment, is continuous with the third lower housing wall 313. One side of the second lower housing wall 312 in the height direction, preferably a lower side in the illustrated embodiment, is continuous with the fourth lower housing wall 314.

The other side of the second lower housing wall 312 in the longitudinal direction, preferably a right side in the illustrated embodiment, partially surrounds the inner housing receiving space 370. A coupling protrusion 360 is formed on one side of the second lower housing wall 312 in the height direction, preferably on an upper side in the illustrated embodiment. The second lower housing wall 312 may be coupled with the upper housing 200 and the inner housing 400 through the coupling protrusion 360.

The third lower housing wall 313 constitutes another side of the lower housing body 310. A third lower housing wall 313 surrounds the lower housing space 320 on another side. In the illustrated embodiment, the third lower housing wall 313 constitutes a rear side of the lower housing body 310. The third lower housing wall 313 is positioned between the fourth outer housing wall 114 and the lower housing space 320.

One side of the third lower housing wall 313, preferably a front side in the illustrated embodiment, is continuous with the first lower housing wall 311. The other side of the third lower housing wall 313 in the width direction, preferably a rear side in the illustrated embodiment, is continuous with the second lower housing wall 312. One side of the third lower housing wall 313 in the height direction, preferably the lower side in the illustrated embodiment, is continuous with the fourth lower housing wall 314.

A screw coupling hole 330 is configured to penetrate the third lower housing wall 313. In the illustrated embodiment, the screw coupling hole 330 is configured adjacent to one side, that is, a lower side, which is continuous with the fourth lower housing wall 314 of the portion of the third lower housing wall 313.

The third lower housing wall 313 may be configured to have a height at a predetermined angle with respect to the vertical direction. In the illustrated embodiment, the third lower housing wall 313 extends inclined from an upper left side toward a lower right side.

The fourth lower housing wall 314 constitutes yet another side of the lower housing body 310. The fourth lower housing wall 314 surrounds the lower housing space 320 on yet another side. In the illustrated embodiment, the fourth lower housing wall 314 constitutes a lower side of the lower housing body 310.

One side of the fourth lower housing wall 314 in the width direction, preferably a front side in the illustrated embodiment, is continuous with the first lower housing wall 311. The other side of the fourth lower housing wall 314 in the width direction, preferably a rear side in the illustrated embodiment, is continuous with the second lower housing wall 312.

The fourth lower housing wall 314 may have a shape corresponding to the shape of the fifth outer housing wall 115. In the illustrated embodiment, the fourth lower housing wall 314 is rounded in a curved shape such that it extends inclined with respect to the horizontal direction from a lower left side to an upper right side.

One side of the fourth lower housing wall 314 in the longitudinal direction, preferably a left side in the illustrated embodiment, is continuous with the third lower housing wall 313 at a predetermined angle. An inner housing receiving space 370 is formed on the other side of the fourth lower housing wall 314 in the longitudinal direction, preferably on a right end in the illustrated embodiment. The fourth lower housing wall 314 supports a lower housing coupler 480 received in the inner housing receiving space 370.

A lower drain hole 340 and a lower drain recess 350 are formed in the fourth lower housing wall 314. Specifically, the lower drain hole 340 is configured to penetrate the fourth lower housing wall 314 adjacent to the one side, that is, a left side, in the longitudinal direction. In addition, the lower drain recess 350 is recessed on the fourth lower housing wall 314 adjacent to the lower drain hole 340.

The lower housing space 320 is a space formed inside the lower housing 300. The lower housing space 320 is defined by being surrounded by the lower housing body 310. In the illustrated embodiment, the lower housing space 320 is surrounded by the lower housing body 310 on each side in the longitudinal direction and on each side in the width direction, that is, the left, right, front, and rear sides.

In addition, one side of the lower housing space 320 in the height direction, preferably an upper side in the illustrated embodiment, is configured open and communicates with the upper housing space 220. In addition, ice stored in the lower housing space 320 may be provided to the outside through the upper side of the lower housing space 320.

The inner housing 400 may be received in the lower housing space 320 through the upper side of the lower housing space 320. The lower housing space 320 communicates with the inner housing space 420 of the received inner housing 400.

The other side of the lower housing space 320 in the height direction, preferably a lower side in the illustrated embodiment, is surrounded by the fourth lower housing wall 314.

The lower housing space 320 may have a shape corresponding to the shape of the lower housing body 310 or the inner housing body 410. In the illustrated embodiment, the lower housing space 320 is configured as a space in a three-dimensional shape having a polygonal cross-section in which a length in the left-right direction is longer than a width in the front-rear direction, and a height in the up-down direction. In this case, the other side, that is, a lower side, of the lower housing space 320 in the height direction is configured to increase its height along the longitudinal direction.

The lower housing space 320 communicates with the outside through the screw coupling hole 330. The screw (not illustrated) may pass through the screw coupling hole 330 and extend in the lower housing space 320.

The lower housing space 320 communicates with the outside through the lower drain hole 340. The residual water in the lower housing space 320 may be drained to the outside through the lower drain hole 340.

The screw coupling hole 330 is a portion where the screw (not illustrated) is coupled with the lower housing 300. The screw coupling hole 330 is configured to penetrate the inside of the third lower housing wall 313. The screw (not illustrated) may pass through the screw coupling hole 330 and enter the lower housing space 320.

The screw coupling hole 330 is positioned adjacent to the fourth lower housing wall 314. In the illustrated embodiment, the screw coupling hole 330 is positioned on the lower side of the third lower housing wall 313. The position of the screw coupling hole 330 may be changed according to the position of the screw support 140 and the screw coupler 460.

The screw coupling hole 330 may have any shape capable of rotatably supporting the screw (not illustrated). In the illustrated embodiment, the screw coupling hole 330 is configured as a disk-shaped space having a circular cross-section and a thickness in the front-back direction.

The lower drain hole 340 is a space where the lower housing space 320 communicates with the outside and drains residual water. The lower drain hole 340 is configured the inside of the fourth lower housing wall 314.

The residual water in the lower housing space 320 may flow along the fourth lower housing wall 314 (or the fourth inner housing wall 414) and may be drained to the outside through the lower drain hole 340. To this end, the fourth lower housing wall 314 may be configured to extend inclined such that the lower drain hole 340 is positioned on the lower side thereof.

The lower drain hole 340 may be positioned on one side adjacent to the third lower housing wall 313 of the portion of the fourth lower housing wall 314. In other words, the lower drain hole 340 may be positioned adjacent to the lowest portion of the portion of the fourth lower housing wall 314.

In the illustrated embodiment, the lower drain hole 340 is positioned adjacent to the one side, that is, a left end of the fourth lower housing wall 314 in the longitudinal direction, but biased toward one side of the lower housing body 310 in the width direction, preferably to a front side in the illustrated embodiment. The position of the lower drain hole 340 may be determined to correspond to the positions of the outer housing drain hole 130 and the inner drain hole 450.

The lower drain hole 340 may be any shape capable of forming a passage through which the residual water of the lower housing space 320 is drained. In the illustrated embodiment, the lower drain hole 340 is configured as a disk-shaped space having a circular cross-section and a thickness in the up-down direction.

The lower drain hole 340 is positioned in the lower drain recess 350.

The lower drain recess 350 is a space for temporarily receiving the residual water flowing toward the lower drain hole 340. When the residual water is generated in a large amount, the residual water may not be drained smoothly through the lower drain hole 340 and may flow back into the lower housing space 320.

Therefore, the lower drain recess 350 is configured to temporarily receive the residual water flowing into the lower drain hole 340 and prevent the residual water from flowing back. The lower drain recess 350 communicates with the lower drain hole 340.

The lower drain recess 350 is recessed on the fourth lower housing wall 314. The lower drain recess 350 may be positioned adjacent to the lower drain hole 340. In an embodiment, the lower drain hole 340 may be positioned inside the lower drain recess 350.

In the illustrated embodiment, the lower drain recess 350 is positioned adjacent to one side of the fourth lower housing wall 314 in the longitudinal side, that is, a left end, to be adjacent to the lower drain hole 340. The lower drain recess 350 may be positioned to overlap the inner drain hole 450.

The lower drain recess 350 may be any shape capable of temporarily receiving the residual water flowing toward the lower drain hole 340. In the illustrated embodiment, the lower drain recess 350 is configured as a polygonal plate-shaped space where a width in the left-right direction is shorter than a length in the front-back direction and which has a thickness in the up-down direction.

The coupling protrusion 360 is a portion where the lower housing 300 is coupled with the upper housing 200 and the inner housing 400. The coupling protrusion 360 is positioned on the one side of the lower housing body 310 in the height direction, preferably on an upper end in the illustrated embodiment. The coupling protrusion 360 is configured to protrude toward the outside of the lower housing 300. In this case, the coupling protrusion 360 may be configured to protrude obliquely with respect to the horizontal direction.

A plurality of coupling protrusions 360 may be provided. The plurality of coupling protrusions 360 may be spaced apart from each other along the outer circumference of the upper ends of the first to third lower housing walls 313. In the embodiment, the coupling protrusions 360 formed on the upper ends of the first lower housing wall 311 and the third lower housing wall 313 are configured to protrude toward the front side and the rear side, respectively. The coupling protrusions 360 formed on the upper end of the second lower housing wall 312 are configured to protrude toward the left side.

Each of the coupling protrusions 360 is inserted into the coupling opening 242 formed in the upper housing coupler 240. Each of the coupling protrusions 360 may be detachably coupled with the upper housing coupler 240.

Each of the coupling protrusions 360 is configured to penetrate a housing coupling groove 472 of the housing coupler 470. Each of the coupling protrusions 360 may be detachably coupled with the housing coupling groove 472.

As described later, the coupling protrusion 360 penetrates the housing coupling groove 472 and is inserted into the coupling opening 242. Accordingly, the upper housing 200, the lower housing 300, and the inner housing 400 may be simultaneously coupled. A detailed description of the coupling structure will be described later.

The coupling protrusion 360 may be provided in any shape in which a coupling state between the upper housing 200 and the inner housing 400 may be stably maintained. In the illustrated embodiment, the coupling protrusion 360 is provided in the form of a hook and is hook-fitted with the coupling opening 242 and the housing coupling groove 472.

To this end, in the illustrated embodiment, the coupling protrusion 360 includes a first coupling extension 361 and a second coupling extension 362.

The first coupling extension 361 constitutes one surface of the coupling protrusion 360. The first coupling extension 361 functions to enable the coupling protrusion 360 to be easily inserted into the housing coupling groove 472 and the coupling opening 242. To this end, the first coupling extension 361 extends at a predetermined angle with respect to the outer surface of the upper end of the lower housing body 310.

In the illustrated embodiment, the first coupling extension 361 is configured to extend outwardly from the upper end of the lower housing body 310. In this case, the first coupling extension 361 is configured such that a height of one end coupled with the lower housing body 310 is higher than the height of the other end in the extension direction.

The first coupling extension 361 is continuous with second coupling extension 362.

The second coupling extension 362 constitutes the other surface of the coupling protrusion 360. The second coupling extension 362 functions to maintain the coupling protrusion 360 coupled with the housing coupling groove 472 and the coupling opening 242. To this end, the second coupling extension 362 extends parallel to an inner surface of the housing coupler 470 surrounding the housing coupling groove 472 or an inner surface of the upper housing coupler 240 surrounding the coupling opening 242.

In the illustrated embodiment, the second coupling extension 362 extends between an end of the first coupling extension 361 and an upper end of the lower housing body 310. In this case, each end of the second coupling extension 362 in the extension direction may be positioned at the same height. The second coupling extension 362 may be supported by the inner surface of the housing coupler 470 or the inner surface of the upper housing coupler 240.

Therefore, the coupling protrusion 360 may be easily coupled with the upper housing coupler 240 and the housing coupler 470, and a state of being coupled with the upper housing coupler 240 and the housing coupler 470 may be stably maintained before an external force in a preset direction is applied.

The inner housing receiving space 370 is a space where the lower housing 300 receives the lower housing coupler 480 of the inner housing 400. The inner housing receiving space 370 is recessed on the other side of the fourth lower housing wall 314 in the longitudinal direction, preferably on a right end in the illustrated embodiment.

The inner housing receiving space 370 communicates with the lower housing space 320. The inner housing 400 may be received in the lower housing space 320 while the lower housing coupler 480 is received in the inner housing receiving space 370.

The inner housing receiving space 370 may have a shape corresponding to the shape of the lower housing coupler 480. In the illustrated embodiment, the inner housing receiving space 370 is configured as a space in a three-dimensional shape having a cross-section of an are formed to be rounded to be convex downward, and a thickness in the front-rear direction.

The inner housing 400 is yet another configuration positioned inside the ice tank assembly 10. The inner housing 400 is respectively coupled with the outer housing 100, the upper housing 200, and the lower housing 300. In this case, the inner housing 400 may be indirectly coupled with the outer housing 100 by the upper housing 200 and the lower housing 300.

The inner housing 400 is received in the outer housing space 120. The inner housing 400 is received in the lower housing space 320 and is supported by the lower housing 300.

The inner housing 400 may be configured to reduce the impact or noise generated by falling ice produced in the upper housing 200. To this end, the inner housing 400 may be formed of a soft material. In an embodiment, the inner housing 400 may be configured to include a material such as silicon.

The inner housing 400 may be disposed to completely wraps around an inner side of the lower housing body 310. That is, the first to fourth lower housing walls 311, 312, 313, and 314 constituting the lower housing body 310 are surrounded by the inner housing 400 and are not exposed to the outside. The arrangement structure may be achieved by the material of the inner housing 400.

Therefore, the residual water generated in the upper housing 200 may not be transferred to the lower housing 300, but may be directly transferred to the inner housing 400, and then drained to the outside. In addition, a gap between the inner housing 400 and the inner surface of the lower housing 300 is closed, and thus the generated residual water is not introduced between the inner housing 400 and the lower housing 300.

Therefore, the formation of a biofilm such as a water stain, which may be generated by the introduced residual water, may be suppressed, and thus hygiene may be improved.

In the embodiments illustrated in FIGS. 14 to 24, the inner housing 400 includes an inner housing body 410, an inner housing space 420, an inner housing rib 430, an inner groove 440, an inner drain hole 450, a screw coupler 460, a housing coupler 470, and a lower housing coupler 480.

The inner housing body 410 constitutes an outer shape of the inner housing 400. The inner housing body 410 is received in the lower housing space 320, and is surrounded by the lower housing body 310. The inner housing body 410 is supported by the lower housing body 310.

The inner housing body 410 may have a shape corresponding to the shape of the lower housing space 320. In the illustrated embodiment, the inner housing body 410 has a three-dimensional shape in which a length in the left-right direction is longer than a width in front-rear direction, and which has a height in the up-down direction.

Another configuration of the inner housing 400 is formed or coupled with the inner housing body 410. In the illustrated embodiment, the inner housing space 420 is configured inside the inner housing body 410. The inner housing rib 430 is configured on an outer circumference of the inner housing body 410.

An inner groove 440 and a lower housing coupler 480 are configured on one side of the inner housing body 410 in the longitudinal direction, preferably on a right end in the illustrated embodiment. The screw coupler 460 is configured on the other side of the inner housing body 410 in the longitudinal direction, preferably a left end in the illustrated embodiment. The inner drain hole 450 is configured on one side of the inner housing body 410 in the height direction, preferably a lower side in the illustrated embodiment, and the housing coupler 470 is configured on the other side of the inner housing body 410 in the height direction, preferably an upper side in the illustrated embodiment.

In the illustrated embodiment, the inner housing body 410 includes a first inner housing wall 411, a second inner housing wall 412, a third inner housing wall 413, and a fourth inner housing wall 414.

The first inner housing wall 411 constitutes one side of the inner housing body 410. The first inner housing wall 411 surrounds the inner housing space 420 on one side. In the illustrated embodiment, the first inner housing wall 411 constitutes a front side of the inner housing body 410. The first inner housing wall 411 is positioned between the first lower housing wall 311 and the inner housing space 420.

The first inner housing wall 411 is disposed to face the second inner housing wall 412 with the inner housing space 420 interposed therebetween along the width direction of the inner housing 400, preferably a front-rear direction in the illustrated embodiment.

One side of the first inner housing wall 411 in the longitudinal direction, preferably a left side in the illustrated embodiment, is continuous with the third inner housing wall 413. One side of the first inner housing wall 411 in the height direction, preferably a lower side in the illustrated embodiment, is continuous with the fourth inner housing wall 414.

The lower housing coupler 480 is configured to protrude on the other side of the first inner housing wall 411 in the longitudinal direction, preferably a right end in the illustrated embodiment.

The second inner housing wall 412 constitutes another side of the inner housing body 410. The second inner housing wall 412 surrounds the inner housing space 420 on another side. In the illustrated embodiment, the second inner housing wall 412 constitutes a rear side of the inner housing body 410. The second inner housing wall 412 is positioned between the second lower housing wall 312 and the inner housing space 420.

The second inner housing wall 412 is disposed to face the first inner housing wall 411 with the inner housing space 420 interposed therebetween along the width direction of the inner housing 400, preferably a front-rear direction in the illustrated embodiment.

One side of the second inner housing wall 412 in the longitudinal direction, preferably a left side in the illustrated embodiment, is continuous with the third inner housing wall 413. One side of the second inner housing wall 412 in the height direction, preferably a lower side in the illustrated embodiment, is continuous with the fourth inner housing wall 414.

The lower housing coupler 480 is configured to protrude on the other side of the second inner housing wall 412 in the longitudinal direction, preferably a right end in the illustrated embodiment.

The third inner housing wall 413 constitutes yet another side of the inner housing body 410. The third inner housing wall 413 surrounds the inner housing space 420 on yet another side. In the illustrated embodiment, the third inner housing wall 413 constitutes a rear side of the inner housing body 410. The third inner housing wall 413 is positioned between the third lower housing wall 313 and the inner housing space 420.

One side of the third inner housing wall 413 in the width direction, preferably a front side in the illustrated embodiment, is continuous with the first inner housing wall 411. The other side of the third inner housing wall 413 in the width direction, preferably a rear side in the illustrated embodiment, is continuous with the second inner housing wall 412. One side of the third inner housing wall 413 in the height direction, preferably a lower side in the illustrated embodiment, is continuous with the fourth inner housing wall 414.

A screw coupler 460 is configured on the third inner housing wall 413. In the illustrated embodiment, the screw coupler 460 is configured adjacent to one side, that is, a lower side, which is continuous with fourth inner housing wall 414 of the portion of the third inner housing wall 413.

The third inner housing wall 413 may be configured to have a height at a predetermined angle with respect to the vertical direction. In the illustrated embodiment, the third inner housing wall 413 extends inclined from the upper left side toward a lower right side. The inclination of the third inner housing wall 413 may be determined to correspond to the inclination of the third lower housing wall 313.

The fourth inner housing wall 414 constitutes still another side of the inner housing body 410. The fourth inner housing wall 414 surrounds the inner housing space 420 on still another side. In the illustrated embodiment, the fourth inner housing wall 414 constitutes a lower side of the inner housing body 410.

One side of the fourth inner housing wall 414 in the width direction, preferably a front side in the illustrated embodiment, is continuous with the first inner housing wall 411. The other side of the fourth inner housing wall 414 in the width direction, preferably a rear side in the illustrated embodiment, is continuous with the second inner housing wall 412.

The fourth inner housing wall 414 may have a shape corresponding to the shape of the fourth lower housing wall 314. In the illustrated embodiment, the fourth inner housing wall 414 is rounded in a curved shape such that it extends inclined with respect to the horizontal direction from a lower left side to an upper right side.

One side of the fourth inner housing wall 414 in the longitudinal direction, preferably a left side in the illustrated embodiment, is continuous with the third inner housing wall 413 at a predetermined angle.

An inner drain hole 450 is configured on one side of the fourth inner housing wall 414.

An inner groove 440 is configured adjacent to the other side of the fourth inner housing wall 414 in the longitudinal direction, preferably a right end in the illustrated embodiment.

The inner housing space 420 is a space formed inside the inner housing 400. The inner housing space 420 is defined by being surrounded by the inner housing body 410. In the illustrated embodiment, the inner housing space 420 is surrounded by the inner housing body 410 on each side in the longitudinal direction and on each side in the width direction, that is, left, right, front, and rear sides.

In addition, one side of the inner housing space 420 in the height direction, preferably an upper side in the illustrated embodiment, is configured open and communicates with the upper housing space 220. In addition, ice received in the inner housing space 420 may be provided to the outside through the upper side or the front upper side of the inner housing space 420.

The other side of the inner housing space 420 in the height direction, preferably a lower side in the illustrated embodiment, is surrounded by the fourth inner housing wall 414.

The inner housing space 420 may have a shape corresponding to the shape of the inner housing body 410. In the illustrated embodiment, the inner housing space 420 is configured as a space in a three-dimensional shape having a polygonal cross-section in which a length in the left-right direction is longer than a width in the front-rear direction, and a height in the up-down direction. In this case, the other side, that is, a lower side, of the inner housing space 420 in the height direction is configured to increase its height along the longitudinal direction.

The inner housing space 420 communicates with the outside through the inner drain hole 450. The residual water of the inner housing space 420 may be drained to the outside through the inner drain hole 450.

The inner housing space 420 communicates with the outside through the screw coupler 460. The screw (not illustrated) may be coupled with the screw coupler 460 and may extend in the inner housing space 420.

The inner housing rib 430 is configured to form a space between an outer circumference of the inner housing body 410 and an inner circumference of the lower housing body 310 so that residual water is introduced between the inner housing body 410 and the lower housing body 310 may flow out.

As described above, the ice tank assembly 10 according to the embodiment of the present invention is configured such that the inner housing 400 completely warps around the lower housing 300. Accordingly, in normal case, residual water is not introduced between the inner housing 400 and the lower housing 300.

However, the residual water may be introduced into a space between the inner housing 400 and the lower housing 300 due to unpredictable factors such as a coupling state of each configuration of the ice tank assembly 10 and an operation state of the device equipped with the ice tank assembly 10.

Accordingly, the ice tank assembly 10 according to the embodiment of the present invention includes an inner housing rib 430 formed on an outer circumference of the inner housing body 410 so that the introduced residual water may be drained without remaining in the lower housing 300 even in the above case.

The inner housing rib 430 is configured to protrude from the outer circumference of the inner housing body 410. The inner housing rib 430 is in contact with the inner circumference of the lower housing body 310. That is, the inner housing 400 may be in contact with the inner circumference of the lower housing body 310 by the inner housing rib 430.

The inner housing rib 430 may be formed on an outer circumference of each portion of the inner housing body 410. In the illustrated embodiment, the inner housing ribs 430 are configured on outer circumferences of the first to fourth inner housing walls 411, 412, 413, and 414, respectively.

The inner housing rib 430 may be provided in any shape capable of separating the outer circumference of the inner housing body 410 from the inner circumference of the lower housing body 310. In the illustrated embodiment, the inner housing rib 430 includes a first rib 431 and a second rib 432.

The first rib 431 constitutes a portion of the inner housing rib 430. The first rib 431 extends in the height direction of the inner housing body 410, preferably in an up-down direction in the illustrated embodiment. A plurality of first ribs 431 may be provided. The plurality of first ribs 431 may be spaced apart from each other of the inner housing body 410 in the longitudinal direction and width direction, preferably in a left-right direction and front-rear direction in the illustrated embodiment.

The second rib 432 constitutes another portion of the inner housing rib 430. The second rib 432 extends in the longitudinal direction or the width direction of the inner housing body 410, preferably in a left-right direction or a front-rear direction in the illustrated embodiment. The second rib 432 may be configured to intersect with the plurality of first ribs 431 at a predetermined angle at a plurality of positions.

The inner groove 440 constitutes a portion where the inner housing 400 is coupled with the upper housing 200. A pressing edge 250 of the upper housing 200 is received in the inner groove 440.

As described above, the pressing edge 250 may cover the inner surface of the fourth inner housing wall 414 surrounding the inner groove 440. Thus, when the inner groove 440 is not formed, the pressing edge 250 is positioned to protrude compared to the fourth inner housing wall 414. In the above case, ice to be provided to the outside may be caught by the pressing edge 250 and thus may not be moved smoothly.

Accordingly, the inner groove 440 is configured on the fourth inner housing wall 414 so that the height of the inner groove 440 protruding upward may be minimized even if the pressing edge 250 covers the inner housing body 410.

Furthermore, the inner groove 440 may guide the residual water generated and falling from the upper housing 200 toward the inner drain hole 450. The residual water falling along the pressing edge 250 may flow along the inner groove 440.

The inner groove 440 is recessed on the fourth inner housing wall 414. The inner groove 440 is positioned adjacent to one side of the fourth inner housing wall 414 in the longitudinal direction, preferably a front side end in the illustrated embodiment. The inner groove 440 is positioned adjacent to the lower housing coupler 480.

The inner groove 440 may be divided into a plurality of portions. In the illustrated embodiment, the inner groove 440 includes a first groove 441 and a second groove 442.

The first groove 441 is a portion that receives the pressing edge 250. The first groove 441 is positioned adjacent to the lower housing coupler 480. The first groove 441 extends in the width direction of the fourth inner housing wall 414, preferably in a front-back direction in the illustrated embodiment. The first groove 441 may have a shape corresponding to the shape of the fourth inner housing wall 414 and the pressing edge 250. In the illustrated embodiment, the first groove 441 is rounded to be convex downward.

The first groove 441 communicates with the second groove 442.

The second groove 442 serves to guide the falling residual water to the inner drain hole 450. The second groove 442 extends in the longitudinal direction of the fourth inner housing wall 414, preferably in a left-right direction in the illustrated embodiment. One side of the second groove 442 in the extension direction, preferably a right end in the illustrated embodiment, communicates with the first groove 441.

The second groove 442 may be configured to have a different shape along its extension direction. In the illustrated embodiment, the second groove 442 is configured such that its cross-sectional area decreases along a direction opposite to the first groove (441), that is, in a direction from right to left. Accordingly, it will be understood that the residual water flowing in the second groove 442 may be more effectively directed toward the inner drain hole 450.

The inner drain hole 450 is a space where the inner housing space 420 communicates with the outside and drains the residual water. The inner drain hole 450 is configured to penetrate the inside of the fourth inner housing wall 414.

The residual water of the inner housing space 420 may flow along the fourth inner housing wall 414 or the inner groove 440 formed thereon to be drained to the outside through the inner drain hole 450. To this end, the fourth inner housing wall 414 may be configured to extend inclined such that the inner drain hole 450 is positioned on a lower side.

The inner drain hole 450 may be positioned on one side adjacent to the third inner housing wall 413 of the portion of the fourth inner housing wall 414. In other words, the inner drain hole 450 may be positioned adjacent to the lowest portion of the portion of the fourth inner housing wall 414.

In the illustrated embodiment, the inner drain hole 450 is positioned adjacent to the other side of the fourth inner housing wall 414 in the longitudinal direction, preferably a right end in the illustrated embodiment. The inner drain hole 450 is positioned opposite to the inner groove 440. The inner drain hole 450 may be disposed to overlap the outer housing drain hole 130, the lower drain hole 340, and the lower drain recess 350.

The inner drain hole 450 may be any shape capable of forming a passage through which the residual water of the inner housing space 420 is drained. In the illustrated embodiment, the inner drain hole 450 is configured as a plate-shaped space having a polygonal cross-section and a thickness in the up-down direction.

A plurality of inner drain holes 450 may be provided. The plurality of inner drain holes 450 may be spaced apart from each other to communicate the inner housing space 420 with the outside at a plurality of positions. In this case, each of the plurality of inner drain holes 450 may be disposed to overlap the lower drain recess 350.

The screw coupler 460 is a portion where a screw (not illustrated) is coupled with the inner housing 400. The screw coupler 460 is configured on the third inner housing wall 413. The screw (not illustrated) may be coupled with the screw coupler 460 and enter the inner housing space 420.

The screw coupler 460 is positioned adjacent to the fourth inner housing wall 414. In the illustrated embodiment, the screw coupler 460 is positioned below the third inner housing wall 413. The screw coupler 460 may be disposed to correspond to the position of the screw support 140 and the screw coupling hole 330.

The screw coupler 460 may have any shape capable of being coupled with the screw coupling hole 330. In the illustrated embodiment, the screw coupler 460 is configured as a cylindrical space having a circular cross-section and extending obliquely in the left-right direction. The screw coupler 460 is coupled through the screw coupling hole 330.

The screw coupler 460 may include a configuration for rotatably supporting the screw (not illustrated) and a configuration for being coupled with the lower housing 300. In the illustrated embodiment, the screw coupler 460 includes a lower housing coupling protrusion 461 and a screw through hole 462.

The lower housing coupling protrusion 461 is configured such that the screw coupler 460 is coupled with the lower housing 300. The lower housing coupling protrusion 461 may be supported by the third lower housing wall 313. That is, the lower housing coupling protrusion 461 is in contact with the outer circumference of the third lower housing wall 313.

Accordingly, the coupling state between the screw coupler 460 and the screw coupling hole 330 may be stably maintained.

The lower housing coupling protrusion 461 may be any shape capable of maintaining the coupling state between the screw coupler 460 and the screw coupling hole 330. In the illustrated embodiment, the lower housing coupling protrusion 461 is configured to have a ring-shaped cross-section protruding radially outward from the outer circumference of the screw coupler 460. The lower housing coupling protrusion 461 may be configured to have a larger outer diameter than the other portions of the screw coupler 460.

As the lower housing coupling protrusion 461 is configured to protrude radially outward, the screw (not illustrated) coupled with the screw coupler 460 may be smoothly rotated without interference.

The screw through hole 462 provides a passage through which the screw (not illustrated) passes. The screw through hole 462 is configured as a hollow penetrating the inside of the screw coupler 460. The screw through hole 462 extends in the longitudinal direction of the screw coupler 460, preferably in a left-right direction in the illustrated embodiment. Each end of the screw through hole 462 in the extension direction is configured open.

The screw through hole 462 may be any shape capable of rotatably receiving the screw (not illustrated). In the illustrated embodiment, the screw through hole 462 is configured as a cylindrical space having a circular cross-section and a length in the front-rear direction.

The housing coupler 470 is a portion where the inner housing 400 is coupled with the upper housing 200 and the lower housing 300, respectively. The housing coupler 470 is positioned on one side of the inner housing body 410 in the height direction, preferably on an upper side in the illustrated embodiment. The housing coupler 470 may extend along an upper end of the first to third inner housing walls 411, 412, and 413.

The housing coupler 470 may be positioned outside the first to third inner housing walls 411, 412, and 413. That is, as best illustrated in FIGS. 22 to 24, the housing coupler 470 is positioned to protrude more toward the front, rear, and left sides, respectively, compared to the first to third inner housing walls 411, 412, and 413.

The housing coupler 470 is coupled with the upper housing coupler 240 and the coupling protrusion 360, respectively. Specifically, the housing coupler 470 receives the coupling protrusion 360 and is received in the upper housing receptacle 241. As described above, the housing coupler 470 and the upper housing coupler 240 may be simultaneously coupled by the coupling protrusion 360.

In the illustrated embodiment, the housing coupler 470 includes a housing receiving space 471 and a housing coupling groove 472.

The housing receiving space 471 is a portion where the housing coupler 470 is coupled with the lower housing 300. The housing receiving space 471 receives an upper end of the lower housing body 310 and the coupling protrusion 360 formed thereon.

The housing receiving space 471 may be defined by being surrounded by the outer circumference of the first to third inner housing walls 411, 412, and 413 and the housing coupler 470. In the illustrated embodiment, an outer side and an upper side of the housing receiving space 471 are surrounded by the outer circumference of the housing coupler 470, and an inner side of the housing receiving space 471 is surrounded by the first to third inner housing walls 411, 412, and 413.

One side of the housing receiving space 471 in the height direction, preferably the lower side in the illustrated embodiment, is configured open. The upper end of the lower housing body 310 and the coupling protrusion 360 may enter the housing receiving space 471 through the one side.

The housing receiving space 471 communicates with the housing coupling groove 472.

The housing coupling groove 472 is a portion where the housing coupler 470 is coupled with the coupling protrusion 360. The housing coupling groove 472 is configured to penetrate a portion of the outer circumference of the housing coupler 470.

The coupling protrusion 360 penetrates the housing coupling groove 472. The coupling protrusion 360 may be coupled with the housing coupling groove 472 and the coupling opening 242 in sequence.

The housing coupling groove 472 may be any shape through which the coupling protrusion 360 may be coupled. In the illustrated embodiment, the housing coupling groove 472 is configured to have a length in the left-right direction and a height in the up-down direction and a rounded rectangular cross-section such that each end in the longitudinal direction is convex outward. The housing coupling groove 472 is disposed to overlap the coupling opening 242.

A plurality of housing coupling grooves 472 may be provided. The plurality of housing coupling grooves 472 may be spaced apart from each other along the upper end of the inner housing body 410 and may be coupled with the plurality of coupling protrusions 360, respectively.

The number and arrangement of the housing coupling grooves 472 may be changed according to the number and arrangement of the coupling openings 242 and the coupling protrusions 360.

The lower housing coupler 480 constitutes a portion where the inner housing 400 is coupled with the lower housing 300. The lower housing coupler 480 is received in the inner housing receiving space 370 and supported by a front end of the fourth lower housing wall 314.

The lower housing coupler 480 is continuous with the inner housing body 410. The lower housing coupler 480 is positioned on one side of the inner housing body 410 in the longitudinal direction, preferably on an outer circumference of right end in the illustrated embodiment.

The lower housing coupler 480 may be any shape that may be received in the inner housing receiving space 370 and be supported by a front end of the fourth lower housing wall 314. In the illustrated embodiment, the lower housing coupler 480 is configured as a ring-shape portion protruding radially outward from the outer circumference of right end of the inner housing body 410.

As the lower housing coupler 480 is formed, the inner housing 400 may be maintained at a position coupled with the lower housing 300 along the longitudinal direction. Accordingly, the inner housing 400 may be maintained in a state in which it surrounds the entire inner circumference of the lower housing body 310.

Referring to FIGS. 25 to 32, a coupling relationship of each configuration of the ice tank assembly 10 according to an embodiment of the present invention is illustrated as an example. For convenience of understanding, the outer housing 100 is omitted.

FIGS. 25 to 28 illustrate a coupling relationship of the lower portion of the upper housing 200, the lower housing 300, and of the inner housing 400.

Referring to FIG. 27, the lower housing coupler 480 of the inner housing 400 is received in an inner housing receiving space 370 formed in a front side of the lower housing body 310. The inner housing receiving space 370 is recessed in the fourth lower housing wall 314.

Accordingly, the left end of the lower housing coupler 480 is supported by a portion surrounding the inner housing receiving space 370 on the left side of the portion of the fourth lower housing wall 314.

In addition, the pressing edge 250 of the upper housing 200 is received in the first groove 441 formed in the fourth inner housing wall 414 and covers a front end of the fourth inner housing wall 414. Accordingly, the residual water falling from the upper housing 200 does not flow between the upper housing 200 and the inner housing 400 or between the lower housing 300 and the inner housing 400.

The first groove 441 communicates with the second groove 442 extending in the left-right direction. Accordingly, the falling residual water may be guided to the inner drain hole 450 along the second groove 442.

Referring to FIG. 28, the screw coupler 460 of the inner housing 400 is coupled through the screw coupling hole 330 of the lower housing 300. In this case, the lower housing coupling protrusion 461 of the screw coupler 460 is positioned outside the lower housing space 320 and is supported by the outer circumference of the third lower housing wall 313.

Therefore, there is no configuration that may interfere with the rotation of a screw (not illustrated) in the screw through hole 462 formed inside the screw coupler 460. Therefore, the screw (not illustrated) may be smoothly rotated.

The inner housing 400 is supported by the lower housing coupling protrusion 461 on one side, that is, a left side, in the longitudinal direction. The other side of the inner housing 400 in the longitudinal direction, that is, a right side, is supported by the lower housing coupler 480. Therefore, the inner housing 400 does not swing along the longitudinal direction, and thus the coupling state between the inner housing 400 and the lower housing 300 may be stably maintained.

FIGS. 29 and 30 illustrate a coupling relationship between a lower portion of the upper housing 200, an upper portion of the lower housing 300, and an upper portion of the inner housing 400.

In the illustrated embodiment, an upper end of the lower housing body 310 and the coupling protrusion 360 formed thereon are received in the housing receiving space 471 and surrounded by an outer circumference of the housing coupler 470.

In addition, an upper end of the inner housing body 410 and the housing coupler 470 formed thereon are received in the upper housing receptacle 241 and surrounded by an outer circumference of the upper housing coupler 240.

In the above state, the coupling protrusion 360 penetrates the housing coupling groove 472 and is inserted into and coupled with the coupling opening 242. Therefore, the upper housing 200, the lower housing 300, and the inner housing 400 may be simultaneously coupled.

In this case, the coupling state between the upper housing 200, the lower housing 300, and the inner housing 400 is stably maintained by the shape of the coupling protrusion 360 as described above.

In the illustrated embodiment, it is assumed that the upper housing 200, the lower housing 300, and the inner housing 400 are coupled by the coupling protrusion 360. Alternatively, the upper housing 200, the lower housing 300, and the inner housing 400 may be coupled by any means for coupling, such a screw or a rivet member in addition to the coupling protrusion 360.

FIGS. 31 and 32 illustrate a communication relationship between the lower portions of the lower housing 300 and the inner housing 400.

The plurality of inner drain holes 450 formed through the fourth inner housing wall 414 are disposed to overlap the lower drain hole 340 or the lower drain recess 350 along the height direction of the ice tank assembly 10, preferably in an up-down direction in the embodiment shown.

The residual water positioned in the inner housing space 420 flows along the fourth inner housing wall 414 extending obliquely toward the inner drain hole 450 and is introduced into the lower drain hole 340 or the lower drain recess 350 through the inner drain hole 450.

The residual water introduced into the lower drain recess 350 may pass through the lower drain hole 340 and the outer housing drain hole 130 in sequence and be drained to the outside. In this case, even if the amount of residual water increases, the backflow of the residual water may be prevented by the lower drain recess 350 as described above.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

| | |
|---|---|
| 10: ice tank assembly | 100: outer housing |
| 110: outer housing body | 111: first outer housing wall |
| 112: second outer housing wall | 113: third outer housing wall |
| 114: fourth outer housing wall | 115: fifth outer housing wall |
| 120: outer housing space | 130: outer housing drain hole |
| 140: screw support | 150: screw coupling opening |
| 200: upper housing | 210: upper housing body |
| 211: first upper housing wall | 212: second upper housing wall |
| 212a: first upper extension part | 212b: second upper extension part |
| 212c: third upper extension part | 213: third upper housing wall |
| 214: fourth upper housing wall | 215: pressing end |
| 220: upper housing space | 230: discharge opening |
| 240: upper housing coupler | 241: upper housing receptacle |
| 242: coupling opening | 250: pressing edge |
| 300: lower housing | 310: lower housing body |
| 311: first lower housing wall | 312: second lower housing wall |
| 313: third lower housing wall | 314: fourth lower housing wall |
| 320: lower housing space | 330: screw coupling hole |
| 340: lower drain hole | 350: lower drain recess |
| 360: coupling protrusion | 361: first coupling extension |
| 362: second coupling extension | 370: inner housing receiving space |
| 400: inner housing | 410: inner housing body |
| 411: first inner housing wall | 412: second inner housing wall |
| 413: third inner housing wall | 414: fourth inner housing wall |
| 420: inner housing space | 430: inner housing rib |
| 431: first rib | 432: second rib |
| 440: inner groove | 441: first groove |
| 442: second groove | 450: inner drain hole |
| 460: screw coupler | 461: lower housing coupling |
| protrusion | 470: housing coupler |
| 462: screw through hole | 472: housing coupling groove |
| 471: housing receiving space | |
| 480: lower housing coupler | |

What is claimed is:

1. An ice tank assembly comprising:
an upper housing configured to have an upper housing space formed therein,
a lower housing configured to be coupled with the upper housing and to have a lower housing space formed therein, wherein the lower housing space communicates with the upper housing space; and
an inner housing configured to be received in the lower housing space and to buffer an impact caused by ice falling from the upper housing space,
wherein the lower housing includes:
a lower housing body surrounding the lower housing space, and
wherein the inner housing includes:
an inner housing body configured to surround entire inner surfaces of the lower housing body.

2. The ice tank assembly of claim 1, wherein the lower housing body includes:
first and second lower housing walls configured to surround the lower housing space on each side in a first direction;
a third lower housing wall configured to surround the lower housing space on one side in a second direction; and
a fourth lower housing wall configured to surround the lower housing space on one side in a height direction, and
wherein the inner housing body includes:
first to fourth inner housing walls configured to surround the first to fourth lower housing walls on an inner side and to be continuous with each other.

3. The ice tank assembly of claim 1, wherein the lower housing includes:
coupling protrusions configured to protrude outward in a first direction and a second direction on an end of the lower housing body in a height direction, and
wherein the inner housing includes:
a housing coupler configured to be positioned on one side of the inner housing body in the height direction and to be coupled with each of the coupling protrusions.

4. The ice tank assembly of claim 3, wherein the housing coupler includes:
a housing receiving space configured to be formed therein and to receive the end of the lower housing body in the height direction and the coupling protrusion; and
a housing coupling groove configured to penetrate a surface surrounding the housing receiving space on an outer side in the first direction and the second direction, wherein the coupling projection is inserted into the housing coupling groove.

5. The ice tank assembly of claim 3, wherein the upper housing includes:
an upper housing body configured to surround the upper housing space; and
an upper housing coupler configured to be positioned on one side of the upper housing body in the height direction and to be coupled with the coupling protrusion and the housing coupler.

6. The ice tank assembly of claim 5, wherein the upper housing coupler includes:
an upper housing receptacle configured to be formed therein and to receive the coupling protrusion and the housing coupler; and
a coupling opening configured to penetrate a surface surrounding the upper housing receptacle on an outer side in the first direction and the second direction, wherein the coupling projection is inserted into the coupling opening.

7. The ice tank assembly of claim 1, wherein the inner housing includes:
an inner housing rib configured to protrude on an outer surface of the inner housing body and to form a space between the outer surface of the inner housing body and the inner surface of the lower housing body.

8. The ice tank assembly of claim 7, wherein the inner housing rib includes:
a first rib configured to extend along a first direction of an outer circumference of the inner housing body; and
a second rib configured to intersect the first rib at a predetermined angle and to extend along a second direction of the outer circumference of the inner housing body.

9. The ice tank assembly of claim 1, wherein the upper housing includes:
a pressing edge configured to be positioned on an end of a third direction and to protrude toward the inner housing to cover the end of the inner housing body in the third direction, and
wherein the inner housing includes:
an inner groove configured to be positioned adjacent to the end of the inner housing body in the third direction and to be recessed on one surface covered by the pressing edge to receive the pressing edge.

10. The ice tank assembly of claim 9, wherein the inner groove includes:
a first groove configured to extend in a fourth direction corresponding to an extension direction of the pressing edge to receive the pressing edge; and
a second groove configured to communicate with the first groove and to extend along the third direction,
wherein the second groove is configured such that its width decreases along a direction opposite to the first groove.

11. The ice tank assembly of claim 1, wherein the upper housing includes:
a plurality of upper housing walls configured to surround the upper housing space on each side in a fifth direction and a sixth direction; and
a pressing end configured to constitute an end of the plurality of upper housing walls in a height direction and to cover the inner housing body on an inner side, and
wherein the one end of the inner housing body in the height direction is covered by the pressing end and is disposed to face the inner housing space surrounded by the inner housing body with the pressing end interposed therebetween.

12. The ice tank assembly of claim 1, wherein the lower housing includes:
an inner housing receiving space configured to be recessed on an end of the lower housing body in a seventh direction, and
wherein the inner housing includes:
a lower housing coupler configured to protrude from an end of the inner housing body in the seventh direction toward the lower housing and to be received the inner housing receiving space.

13. The ice tank assembly of claim 1, wherein the lower housing includes:
a screw coupling hole configured to penetrate an end of the lower housing body in a ninth direction, wherein a screw is coupled through the screw coupling hole,
wherein the inner housing includes:
a screw coupler configured to be positioned on an end of the inner housing body in the ninth direction, wherein the screw coupler is coupled through the screw coupling hole, and the screw is coupled through the screw coupler.

14. The ice tank assembly of claim 13, wherein the screw coupler includes:
a lower housing coupling protrusion configured to protrude radially from an end of its extension direction and to be supported by an outer surface of the lower housing body; and
a screw through hole configured to penetrate the inside thereof, wherein the screw penetrates the screw through hole.
